(19) United States
(12) Patent Application Publication
(10) Pub. No.: US 2006/0177612 A1
(43) Pub. Date: Aug. 10, 2006

(54) Curl-resistant heat-shrinkable packaging

(76) Inventor: Matt Peterka, Oshkosh, WI (US)

Correspondence Address: BRINKS HOFER GILSON & LIONE, P.O. BOX 10395, CHICAGO, IL, 60610, US

(21) Appl. No.: 11/051,151

(22) Filed: Feb. 4, 2005

(51) Int. Cl. F16B 4/00

(52) U.S. Cl. 428/34.9; 428/35.2

(57) ABSTRACT

Heat-shrinkable multilayer packaging articles resistant to curling are provided, for example, for bone-in meat products. Preferred packaging articles comprise a heat-shrinkable packaging assembly having an exterior film affixed to one exterior side of a heat-shrinkable food storage bag, where the total free shrink value of the exterior film is greater than the total free shrink value of the film forming the heat-shrinkable food storage bag. Other packaging articles include a laminate bag for bone-in meat products having two puncture-resistant heat shrinkable laminates affixed to opposite sides of a heat-shrinkable multilayer tubular film bag, where one laminate has a higher total free shrink value than the bag or the laminate on the opposite side of the film bag. The laminate bag can further comprise an oxygen barrier layer and a heat sealing region. Methods of making curl-resistant heat-shrinkable packaging articles are also provided.

Curl-resistant heat-shrinkable packaging enclosures, and food packages comprising the same, are provided herein. The packaging enclosures are useful, for example, as bags for packaging meat, and in particular, as heat-shrinkable bags having a protective laminate for packaging bone-in primal cuts of meat.

### BACKGROUND

Manufacturers and wholesalers use flexible thermoplastic packaging films to provide economical, sanitary containers, which help protect and/or preserve the freshness and wholesomeness of their products. These films are often sold in bag form. For example, a single-layer or multilayer film is made into bags using a tubular film or one or more flat sheets or webs of film by well-known processes involving processes such as cutting, folding and/or sealing the film to form bags. These films and bags may be printed and may also be uniaxially- or biaxially-oriented, heat-shrinkable, irradiated, or may contain film layers which are abuse-resistant or puncture-resistant or which are crosslinked or which enhance or retard or prevent transmission of light, gases, or liquids therethrough. For example, a tube of a thermoplastic film may be formed into bags by heat sealing across the tube and laterally cutting the tube between sealed portions.

Typically, at least a portion of a thermoplastic film for use in making a food packaging bag can be heat-sealed to create a food storage chamber, and to seal the food storage chamber closed after insertion of the food product. Typically, heat seals are made by applying sufficient heat and pressure to adjacent film layer surfaces for a sufficient time to cause a fusion bond between the plastic film layers. Suitable methods for forming a heat seal include hot bar sealing and impulse sealing. For example, an impulse seal is made by application of heat and pressure using opposing bars similar to the hot bar seal except that at least one of these bars has a covered wire or ribbon through which electric current is passed for a very brief time period (hence the name “impulse”) to cause the adjacent film layers to fusion bond. Following the impulse of heat, the bars are typically cooled (e.g. by circulating coolant) while continuing to hold the interior surface of the bag together to achieve adequate sealing strength.

A food packaging bag may be made from a tube stock of thermoplastic heat-shrinkable multilayer plastic film by making one bottom seal transverse to the tubular film. Once the bottom seal is made, the tube stock can be transversely cut to form the mouth of the bag.

Food packages formed of heat-shrinkable thermoplastic film can be used for packaging food products such as primal cuts of meat. For example, a primal cut can be loaded into a bag formed from a tube of a heat-shrinkable multilayer thermoplastic film. The bag can then be evacuated and heat sealed to form a closed package. Next the package can be exposed to warm water or other heating means to cause the bag to shrink and form fit the primal cut.

However, some food products, such as bone-in cuts of meat, often include sharp projections, such as bones that protrude outwardly from the meat. When bone-in meat is packaged, the protruding bones often puncture or tear packaging material that is not sufficiently puncture-resistant. Many heat-shrinkable thermoplastic films used as bags for packaging bone-in meat products are relatively thin and can be unsatisfactory for packaging cuts of meat which contain bone. For example, the ribs or other sharp bone protrusions, such as those contained in primal and subprimal rib beef cuts or pork ribs, may puncture the bag during the evacuation of air from the bag or during heat shrinking as the bag draws tightly about the bone-in meat cut. A puncture in the bag is undesirable as it allows the meat in the area of the puncture to be exposed to oxygen can shorten the shelf life of the packaged product. Problems related to punctures by sharp projections in food products can be further compounded by abrasion between adjacent packages caused by vibration and movement of the meat packages one against another during transport and handling.

To enhance the puncture resistance of a heat-shrinkable thermoplastic film bag, thicker bags may be employed, as may bags made of special abrasion- or puncture-resistant materials or structures. For example, one or more laminates can be affixed to the bag to form a laminate bag. Also, patches of films or other puncture-resistant or abrasion-resistant materials, either heat-shrinkable or not, may be affixed to a bag or substrate in areas where contact with bone edges or portions is expected. Puncture-resistant patches are typically located on the outside of the bag and laminates may be employed to substantially or completely cover either or both sides of films or bags made therefrom. For example, one or more oriented, heat-shrinkable single-layer or multilayer laminate films can be affixed to one or more sides of a heat-shrinkable thermoplastic film bag to enhance the puncture-resistant properties of the resultant food package, while preserving an acceptable level of heat shrinkability. The shrink properties of the laminate can be matched to those of the bag to reduce the likelihood of delamination of the laminate from the bag during heat shrinking.

Heat shrinkable packaging for storing food having sharp projections preferably has a high level of shrinkability and shrink force to maintain a desirably tight appearance of the shrunk package around the product, as well as sufficient puncture-resistant properties. It is also generally known that selection of heat-shrinkable films for packaging food products includes consideration of such criteria as barrier properties, cost, durability, flex-crack resistance, FDA approval, machinability, optical properties such as gloss and haze, printability, sealability, shrinkability, shrink force, stiffness, and strength.

However, thermoplastic heat-shrinkable packaging having desirably high levels of heat shrinkability, shrink force and puncture resistance, can also have a tendency to produce a packaged product that undesirably distorts the shape of the product, resulting in a packaged product that is more curled or bent than the pre-packaged product. An example of a thermoplastic heat-shrinkable package that distorts upon sealing is provided in FIG. 1A and FIG. 1B. Referring to FIG. 1A, an unsealed laminate bag 10A formed from a multilayer thermoplastic heat-shrinkable film tube is shown enclosing a bone-in meat product 120 within a food storage chamber 12. As shown in FIG. 1B, the bone-in meat product 120 has a plurality of bones 121 (cross section), a meat side 124, and a bone side 122. The unsealed laminate bag 10A has a first end 102 and a second end 104 that are substantially co-planar along a plane containing a laminate bag longitudinal axis 106. In the unsealed laminate bag 10A, the food storage chamber 12 is enclosed on three sides by a seal 14 in the film tube, and has an opening 100. FIG. 1B shows a side view of laminate bag 10A after evacuation and sealing of the food storage chamber 120. To seal the laminate bag, the food storage chamber 12 is evacuated, the opening 100 is sealed to form a closing seal 16, and the laminate bag is heated to shrink fit the bag to the bone-in meat product 120 to form a sealed laminate bag 10B. When the laminate bag has a high free shrink value, the packaged bone-in meat product 120, which is substantially flat before packaging, can curl or bend into a “C” shape in the sealed laminate bag 10B. This distortion of the shape of the packaged product can hinder packing multiple-packaged products in a single shipping container. In the sealed laminate bag 10B of FIG. 1B, curling of the bone-in meat product 120 is indicated by a first raised portion 13 at the first end 102 and a second raised portion 15 at the second end 104. Each raised portion was substantially within the plane containing the laminate bag axis 106 in the unsealed laminate bag 10A (see FIG. 1A), but is elevated from the plane of the laminate bag longitudinal axis 106 in the sealed laminate bag 10B (see FIG. 1B).

What is needed to address this problem is thermoplastic heat-shrinkable packaging that maintains desirably high levels of heat-shrinkability and puncture resistance, while reducing, minimizing or eliminating the distortion of sealably-packaged bone-in food products contained therein.

### SUMMARY

In a first embodiment, a heat-shrinkable packaging assembly is provided comprising a heat-shrinkable bag film and a first heat-shrinkable exterior film sheet affixed to an exterior surface of the bag film, where the first heat-shrinkable exterior film sheet has a higher total free shrink value at 90° C. than the total free shrink value at 90° C. of the heat-shrinkable bag film. The packaging assembly can optionally further comprise a second heat-shrinkable exterior film sheet affixed to a portion of the exterior surface of the bag film, preferably opposite the first heat-shrinkable exterior film sheet. Preferably, the second heat-shrinkable exterior film sheet has a lower total free shrink value at 90° C. than the total free shrink value at 90° C. of the first exterior heat-shrinkable film sheet. In one aspect, the first heat-shrinkable exterior film sheet has a shrink force that is greater than the shrink force of the heat-shrinkable bag film. In another aspect, the first heat-shrinkable exterior film sheet has a shrink force that is greater than the shrink force of the second heat-shrinkable exterior film sheet.

In a second embodiment, a bone-in food product storage bag is provided comprising a heat-shrinkable tube member and a heat-shrinkable first laminate film affixed to an exterior surface of the tube member, where the heat-shrinkable first laminate film has a higher total free shrink value at 90° C. than the total free shrink value at 90° C. of the heat-shrinkable tube member. The bone-in food product storage bag preferably further comprises a heat-shrinkable second laminate film affixed to an exterior surface of the tube member. Preferably, the heat-shrinkable second laminate film has a lower total free shrink value at 90° C. than the total free shrink value at 90° C. of the heat-shrinkable first laminate film. In one aspect, the heat-shrinkable first laminate film has a shrink force that is greater than the shrink force of the heat-shrinkable tube member. In another aspect, the heat-shrinkable first laminate film has a shrink force that is greater than the shrink force of the heat-shrinkable second laminate film.

In a third embodiment, a laminate bag is provided comprising: a heat-shrinkable bag having an exterior surface and an interior surface, the interior surface defining a product receiving chamber, with one or more heat-shrinkable laminate(s) affixed to the exterior surface. In one aspect, a laminate bag comprises a heat-shrinkable bag having a first heat-shrinkable laminate affixed to the exterior surface of the bag, where the first heat-shrinkable laminate has a greater total free shrink value at 90° C. than the total free shrink value of the heat-shrinkable bag at 90° C. In another aspect, a laminate bag comprises a heat-shrinkable bag having a first heat-shrinkable laminate and an opposable second heat-shrinkable laminate affixed to the exterior surface of the bag, where the first heat-shrinkable laminate has a greater total free shrink value at 90° C. than both the total free shrink values of both the heat-shrinkable bag and the second heat-shrinkable laminate at 90° C. In one aspect, the first heat-shrinkable laminate has a shrink force that is greater than the shrink force of the heat-shrinkable tube member. In another aspect, the first heat-shrinkable laminate has a shrink force that is greater than the shrink force of the second heat-shrinkable laminate.

In some aspects, the heat-shrinkable bag film or the heat-shrinkable tube member can comprise a multilayer heat-shrinkable film. In some aspects, the multilayer heat-shrinkable film includes a core oxygen-barrier layer positioned between an exterior layer and an interior layer. In one aspect, the exterior layer is affixed to an exterior film sheet or a laminate film. In one aspect, the interior layer defines a product receiving chamber. In some aspects, the heat-shrinkable food package can further comprise a sealant layer positioned at or near the interior surface of the package, for example as an interior layer. One or more adhesive layer(s) may also be included in a tube member or bag film. The food packages can further include an one or more adhesive layers positioned between an exterior layer and an interior layer.

In a fourth embodiment, a method of forming a puncture-resistant bag is provided. The method can comprise providing a continuous heat-shrinkable tube film and affixing a first laminate film with a higher total free shrink value at 90° C. than the tube film to the exterior surface of the tube film. Optionally, in one aspect, the methods of forming the puncture-resistant bag further comprise one or more of the following steps: affixing a second laminate film to the exterior surface of the heat-shrinkable tube film, providing a lateral seal through the tube film, or providing a cut laterally through a portion of the tube film. Optionally, in another aspect, the methods of forming the puncture-resistant bag further comprise one or more of the following steps: affixing a second laminate film to the exterior surface of the tube film; providing a first lateral seal extending laterally across the width of the tube film; providing a second lateral seal extending laterally across the width of the tube film, substantially parallel to the first lateral seal and positioned at a first distance from the first lateral seal; or providing a cut laterally through the tube film substantially perpendicular to the first lateral seal, the cut extending laterally across at least the first distance between the first lateral seal and the second lateral seal. Preferably, the second exterior film sheet has a total free shrink value at 90° C. that is at least 10 total free shrink percentage points less than the total free shrink value at 90° C. for the first exterior film sheet.

The compositions, films and packages provided herein are useful to process and/or package articles, especially foodstuffs that are prone to shape distortions, such as bending or curling, when packaged in heat-shrinkable packaging. Preferably, the heat shrinkable packaging is suitable for providing food product packages that resist curling when the bag film has a total free shrink value at 90° C. of at least about 60%, although other uses are also provided.

The food packages provided herein have various uses, and are suitable for use in packaging food products with sharp edges, such as bone-in meat products. Certain exemplary embodiments are described in the Detailed Description of Preferred Embodiments below.

### BRIEF DESCRIPTION OF THE DRAWINGS

FIG. 1A shows a top plan view of a heat-shrinkable thermoplastic bag.

FIG. 1B shows a side cross-sectional view of the bone-in meat product in the bag of FIG. 1A that has curled after sealing of a bone-in meat product.

FIG. 2A shows a top view of a curl-resistant heat-shrinkable packaging assembly comprising a product receiving chamber and a heat-shrinkable exterior film.

FIG. 2B shows a longitudinal cross-sectional side view across line A-A′ of the packaging assembly of FIG. 2A.

FIG. 2C shows a lateral cross-sectional side view across line B-B′ of the packaging assembly of FIG. 2A.

FIG. 3A shows a top plan view of a curl-resistant heat-shrinkable bone-in food product storage bag comprising a product receiving chamber and a heat-shrinkable laminate film affixed to the exterior surface of the body portion of the storage bag.

FIG. 3B shows a longitudinal cross-sectional side view across line C-C′ of the bone-in food product storage bag of FIG. 3A.

FIG. 4A shows a cross-sectional schematic of a multilayer heat-shrinkable film.

FIG. 4B shows a cross-sectional schematic of a multilayer heat-shrinkable film.

### DETAILED DESCRIPTION OF PREFERRED EMBODIMENTS

In discussing plastic film packaging, various polymer acronyms are used herein and they are listed below. Also, in referring to blends of polymers, a colon (:) will be used to indicate that the components to the left and right of the colon are blended. In referring to film structure, a slash (/) will be used to indicate that components to the left and right of the slash are in different layers and the relative position of components in layers may be so indicated by use of the slash to indicate film layer boundaries. Acronyms commonly employed herein include:

EAA—Copolymer of ethylene with acrylic acid

EVA—Copolymer of ethylene with vinyl acetate

EVOH—A saponified or hydrolyzed copolymer of ethylene and vinyl acetate

MA Saran—methyl acrylate and vinylidene chloride copolymer

PE—Polyethylene (an ethylene homopolymer and/or copolymer of a major portion of ethylene with one or more α-olefins)

PP—Polypropylene homopolymer

PVDC—Polyvinylidene chloride (also includes copolymers of vinylidene chloride, especially with vinyl chloride), also referred to as Saran

The following terms are defined for the purposes of this application only, in the following manner.

The term “exterior layer” refers to a layer comprising the outermost surface of a film or product. The direction “exterior” refers to a direction radially away from the center of a packaging article, for example in the direction away from an interior product receiving chamber lumen and toward an outermost handling surface of a food package.

The term “interior layer” refers to a layer comprising the innermost surface of a film or product. For example, an interior layer forms the interior surface of an enclosed package, for example the surface of an internal product receiving chamber. The directions “interior” or “inner” refer to a direction radially toward the center of a package, for example in the direction toward an interior product receiving chamber lumen and away from an outermost handling surface of a food package.

A “core layer” refers to a layer positioned between at least two other layers.

As used herein, the term “barrier,” and the phrase “barrier layer,” as applied to films and/or film layers, are used with reference to the ability of a film or film layer to serve as a barrier to one or more gases or moisture. Preferably, a barrier layer material will reduce the oxygen permeability of a film (used to form the bag) to less than 70 cc per square meter in 24 hours at one atmosphere at a temperature of 73° F. (23° C.) and 0% relative humidity. These values should be measured in accordance with ASTM standard D-1434.

The expression very low-density polyethylene (“VLDPE”), sometimes called ultra low-density polyethylene (“ULDPE”), refers to linear and non-plastomeric polyethylenes having densities below about 0.915 g/cm³. This expression does not include ethylene alpha olefin copolymers of densities below about 0.900 g with elastomeric properties and referred to by at least one manufacturer as “ethylene alpha olefin plastomers.” However, ethylene alpha olefin plastomers may be used as a constituent in any layer, such as a laminate interior surface and/or bag exterior surface, as long as they do not prevent the surface from performing its intended function. VLDPE does not include linear low-density polyethylene (LLDPE), which has densities above 0.915 gm/cm³, preferably in the range of 0.915-0.930 gm/cm³.

As used herein, “EVOH” refers to ethylene vinyl alcohol copolymer. EVOH includes saponified or hydrolyzed ethylene vinyl acetate copolymers, and refers to a vinyl alcohol copolymer having an ethylene comonomer, and prepared by, for example, hydrolysis of vinyl acetate copolymers, or by chemical reactions with polyvinyl alcohol. The degree of hydrolysis is preferably from about 50 to 100 mole percent, more preferably, from about 85 to 100 mole percent.

As used herein, the phrase “machine direction,” herein abbreviated “MD,” refers to a direction “along the length” of the film, i.e., in the direction of the film as the film is formed during extrusion and/or coating. As used herein, the phrase “transverse direction,” herein abbreviated “TD,” refers to a direction across the film, perpendicular to the machine or longitudinal direction.

In this application, the term “heat-shrinkable” means that an article of manufacture has an unrestrained shrinkage of at least 10% in each of the transverse direction (TD) and machine direction (MD) measured at 90° C. (194° F.). Preferably, a heat-shrinkable article has an unrestrained shrinkage of at least 20% in each direction and most preferably the shrink is at least 40% or more in both directions. Measuring the unrestrained shrink value of a thermoplastic film is accomplished by a procedure described below, which is derived from ASTM D2732.

In this application, the term “total free shrink” refers to the sum of the unrestrained shrink value in the transverse direction plus the unrestrained shrink value in the machine direction measured at the temperature specified. For example, a film with a TD unrestrained free shrink values measured at 90° C. of 35% TD and 40% MD (“35×45”) has a total free shrink value measured at 90° C. of 80% (35+45=80). Preferably, the total free shrink value is measured at 90° C. by the procedure described below, derived from ASTM D2732.

In this application, “total free shrink percentage points” refers to the total percentage of the total free shrink value. For example, a first film with a total free shrink value at 90° C. of 80% has 80 total free shrink percentage points. Similarly, if a first film has “a total free shrink value at 90° C. of 10%,” and a second film has “a total free shrink value at 90° C. that is 10 total free shrink percentage points greater than the first film,” then the second film has a total free shrink value at 90° C. that is (10+10)%, or 20%. In contrast, a second film with “a total free shrink value at 90° C. that is 10% greater than the first film” has a has a total free shrink value at 90° C. that is 10% greater than 10%, or 11%. Similarly, if the first film has a total free shrink value at 90° C. of 80% (i.e., 80 total free shrink percentage points), and the second film has “a total free shrink value at 90° C. that is 10 total free shrink percentage points greater than the first film,” then the second film has a total free shrink value at 90° C. that is (80+10)%, or 90%.

The terms “about” or “substantially” used with reference to a quantity refer to variations in the recited quantity that are equivalent to the quantity recited, for instance an amount that is insubstantially different from a recited quantity for an intended purpose or function. Variation of a quantity or relationship modified by terms “about” or “substantially” include variations based on the general guidelines contained in the specification as read by one of ordinary skill in the art. In this application, recitation of “about” a total free shrink value as a percentage refers to variation of 5% higher or lower than the recited total free shrink value (for example, a total free shrink of “about 60%” includes total free shrink values between 55% and 65% measured under the same conditions). In this application, recitation of “about” followed by a range of percentage values refers to “about” both the lower and the upper value (for example, “about 10%-20%” means “about 10% to about 20%”).

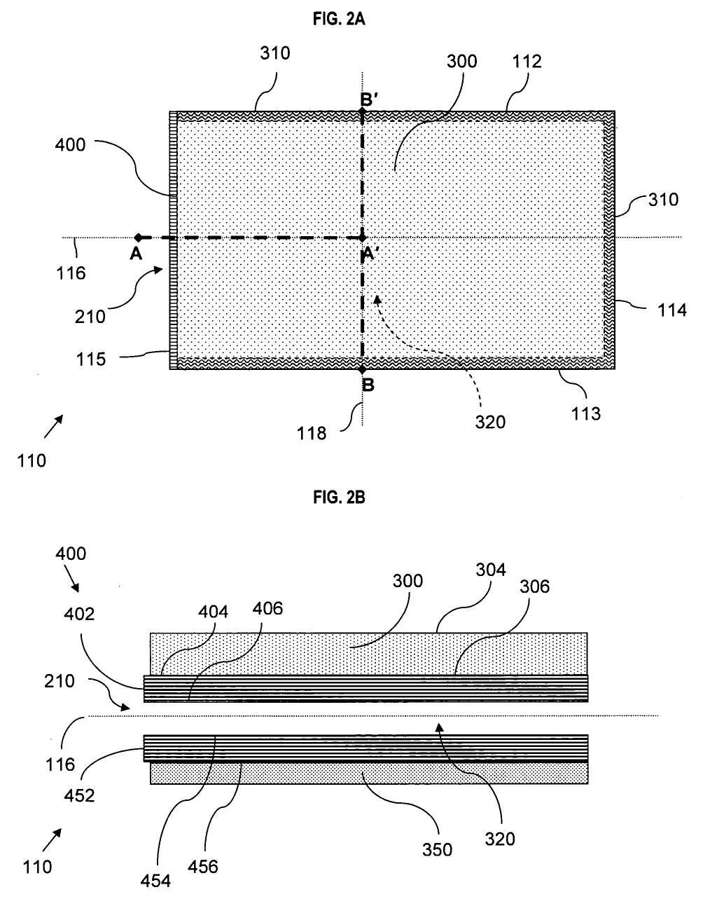

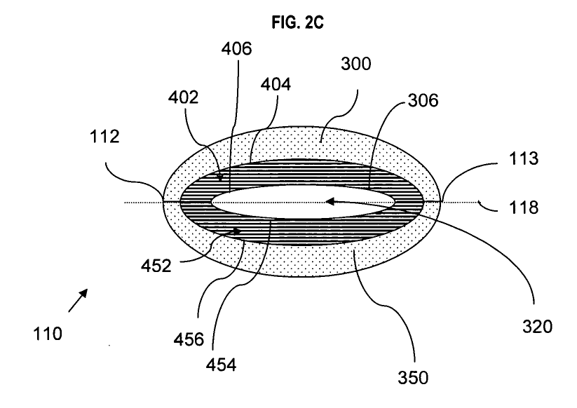

The term “opposable to” refers to placement of a first structure substantially opposite from a second structure. For example, in the packaging assembly 110 illustrated in FIG. 2B, a first exterior film sheet 300 is opposable to a second exterior film sheet 350. Similarly, a first wall 402 is opposable to the second wall 452.

In a first embodiment, some aspects of which are shown in FIG. 2A, FIG. 2B, and FIG. 2C a heat-shrinkable packaging assembly 110 is provided comprising a heat-shrinkable bag film 400 and a first heat-shrinkable exterior film sheet 300 affixed to an exterior surface 404 of the bag film. FIG. 2B shows a first cross section of the heat-shrinkable packaging assembly of FIG. 2A along the line segment A-A′ of a hypothetical longitudinal line 116 indicated in both figures. The packaging assembly can optionally further comprise a second heat-shrinkable exterior film sheet 350 affixed to an exterior surface of the bag film 456. The bag film 400 can have a first wall 402 joined about a portion of its periphery opposable to a second wall 452 to form a product receiving chamber 320. The product receiving chamber 320 is shown with an opening 210 that can be sealed along edge 115 to seal the product receiving chamber 320 closed. The first wall 402 can be joined to the second wall 452 by any suitable manner. Preferably, the first wall 402 is coextruded with the second wall 452 to form a continuous tube defining an interior lumen that forms the product receiving chamber 320. In the packaging assembly 110 illustrated in FIG. 2A and FIG. 2B, a continuous seal 310 is formed around three edges 112, 113, 114 of the packaging assembly 110, thereby enclosing three sides of the product receiving chamber 320 when the package is open. The open package comprises an opening along edge 115. A seal can be formed along edge 115 to close the opening 210 of the product receiving chamber 320.

In another aspect, the first wall 402 and the second wall 452 can alternatively be two separate films that are joined by forming a seal 310 along one or more edges of the periphery of two overlapping film sheets. In yet another aspect, the first wall 402 and the second wall 452 can also be formed from overlapping portions of a single film that is folded over itself. For instance, the folded portion of single film sheet can form one edge of the product receiving chamber 320, and two edges of the overlapping portions of the sheet forming the first wall 402 and the second wall 452 can be sealed along the overlapping edges of the single film sheet to form more edges of the product receiving chamber 320. The remaining edge of the product receiving chamber can be used to form an opening 100 that can be sealed after introduction of a food product.

A seal preferably extends between the first wall 402 and the second wall 452, but can also optionally extend through portions of the first film sheet 300, the second film sheet 350 or all three structures. In FIG. 2B, the seal 310 extends through the first wall 402 and the second wall 452, as well as the first film sheet 300, and the second film sheet 350.

The first wall 402 has an interior surface 406 and an exterior surface 404; the second wall 452 has an interior surface 454 and an exterior surface 456. The product receiving chamber 320 can be defined between an interior surface 406 of the first wall 402 and an interior surface 454 of the second wall 452.

One or more heat-shrinkable exterior film sheet(s) can be affixed to one or more exterior surface(s) of the wall(s) of the bag film to form the packaging assembly. One or more heat-shrinkable exterior film sheet(s) can be affixed to at least a portion of the surface area of an exterior surface of the first wall of the bag film, and preferably cover a major portion of the surface area of the exterior surface of the first wall or the second wall of the bag film.

Preferably, the heat-shrinkable packaging assembly 110 comprises a first heat-shrinkable exterior film sheet 300 that is affixed to and covers a major portion of the surface area of the exterior surface 404 of the first wall 402, preferably with minimal incidence of delamination. The first exterior film sheet 300 is preferably affixed to a first exterior surface of the first wall of the bag film. The first heat shrinkable exterior film sheet 300 has an exterior surface 304 and an exterior surface 306. The first exterior film sheet 300 preferably has a total free shrink value at 90° C. that is at least 10 total free shrink percentage points greater than the total free shrink value at 90° C. of the bag film. In one particularly preferred aspect of the first embodiment, the exterior film preferably has a total free shrink value at 90° C. that is about 15-80 total free shrink percentage points, more preferably about 25-80 total free shrink percentage points, most preferably about 30-80 total free shrink percentage points greater than the total free shrink value at 90° C. of the bag film 400. In one aspect, the exterior film has a total free shrink value at 90° C. that is about 30 total free shrink percentage points, such as 29 total free shrink percentage points, greater than the total free shrink value at 90° C. of the bag film 400. The first exterior film sheet 300 is believed to impart curl-resistant properties to the packaging assembly and may be adapted to provide puncture-resistant properties as well.

Optionally, the heat-shrinkable packaging assembly 110 further comprises a second heat-shrinkable exterior film sheet 350 affixed to the exterior surface 456 of the second wall 452 of the bag film 400, for example to impart additional puncture-resistant properties to the packaging assembly 110. Preferably, the second exterior film sheet 350 is affixed to a second exterior surface 456 of the second wall 452 of the bag film 400, preferably with minimal incidence of delamination. The second exterior film sheet 350 has an interior surface 354 and an exterior surface 356. The first exterior film sheet 300 preferably has a total free shrink value at 90° C. that is at least 10 total free shrink percentage points greater than the total free shrink value at 90° C. of the second exterior film sheet 350. Preferably, the second exterior film sheet 350 is opposable to the first exterior film sheet 300 in the packaging assembly 110.

In one aspect of the first embodiment, shown in FIGS. 2A-2C, the packaging assembly comprises (a) a bag film 400 having a total free shrink value at 90° C. that is at least about 80%, (b) a first exterior film sheet 300 affixed to the exterior surface 404 of a first film wall 402 having a total free shrink value at 90° C. that is at least about 10 total free shrink percentage points greater than the total free shrink value at 90° C. of the bag film 400, and (c) a second exterior film sheet 350 affixed to the exterior surface 456 of a second film wall 452 having a total free shrink value at 90° C. that is about 10 total free shrink percentage points less than the total free shrink value at 90° C. of the first exterior film sheet 300.

FIG. 2C shows a lateral cross-sectional side view of the package enclosure of FIG. 2A. The lateral axis 118 is shown in both FIG. 2B and in FIG. 2C to orient the drawings. FIG. 2C shows a cross section of FIG. 2A along the B-B′ portion of the lateral axis 118. The packaging assembly 110 comprises a product receiving chamber 320 defined by the interior surface 406 of the first wall 402, and the interior surface 454 of the second wall 452. In one aspect, the first wall 402 and the second wall 452 are joined along a first edge 112, along a second edge 113 and optionally along a third edge 114 (not shown in FIG. 2C). The exterior surface 404 of the first wall 402 is affixed to the interior surface 306 of the first exterior film sheet 300. Optionally, the interior surface of the second exterior film sheet 350 can be affixed to the exterior surface 456 of the second wall 452.

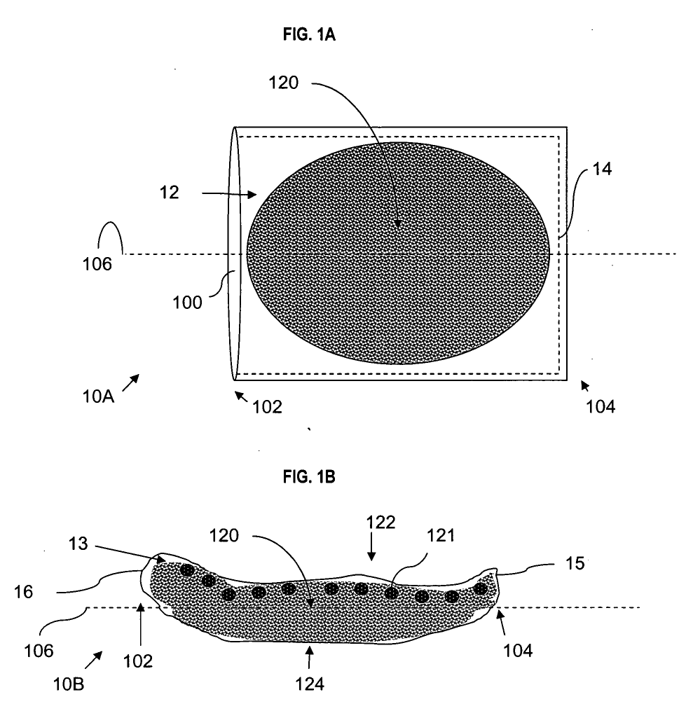

In another aspect of the first embodiment, a heat-shrinkable exterior film sheet can be affixed to a previously assembled laminate bag that is prone to distortion upon sealing of a food product in a product receiving chamber. The exterior film sheet is selected with a total free shrink at 90° C. that is at least 10 total free shrink percentage points, or more preferably about 20, 30, 40, 50, 60, 70, 80, 90, or 100 total free shrink percentage points, or any increment of 1, 0.25 or 0.1 therebetween, greater than the total free shrink value at 90° C. of either the film bag or other layers or laminates of the assembled laminate bag. Preferably, the exterior film sheet can have any total free shrink value at 90° C. up to a maximum of about 180%. For example, the heat-shrinkable package 10A of FIG. 1A can be modified by adhering a heat-shrinkable exterior film sheet to the meat side 124 of the heat-shrinkable laminate bag, where the exterior film sheet has a total free shrink value at 90° C. that is at least 10 total free shrink percentage points greater than the total free shrink value at 90° C. of the film tube enclosing the bone-in food product 120 in the heat-shrinkable package 10A.

In one aspect, a heat-shrinkable packaging assembly comprises a bag film with a first total free shrink value at 90° C., a first exterior film sheet with a second total free shrink value at 90° C., and a second exterior film sheet with a third total free shrink value at 90° C. Preferably, the second total free shrink value is at least 10 total free shrink percentage points, and more preferably 20, 30, 40, 50, 60, 70, 80, 90, or 100 total free shrink percentage points, or any interval of 1%, 0.1% or 0.01% therebetween, greater than the first total free shrink or the third total free shrink value. In another aspect, the second total free shrink value is within about 10%, 20%, 30%, 40%, 50%, 60%, 70%, or 80% of the third total free shrink value, or within about 10, 20, 30, 40, 50, 60, 70, or 80 total free shrink percentage points of the third total free shrink value. In yet another aspect, the third total free shrink value is about the same as the first total free shrink value. In yet another aspect, the third total free shrink value is within about 10%, 20%, 30%, 40%, 50%, 60%, 70%, or 80% of the first total free shrink value, or within about 10, 20, 30, 40, 50, 60, 70, or 80 total free shrink percentage points of the first total free shrink value.

In one preferred aspect of the first embodiment, the packaging assembly comprises (a) a tube member having a total free shrink value at 90° C. that is at least about 80%, (b) a first laminate film affixed to the first tube exterior surface, the first laminate film having a total free shrink value at 90° C. that is at least about 10 total free shrink percentage points greater than the total free shrink value at 90° C. of the tube member, and (c) a second laminate film affixed to the second tube exterior surface, the second laminate film having a total free shrink value at 90° C. that is about 10 total free shrink percentage points less than the total free shrink value at 90° C. of the first laminate film.

In another preferred aspect of the first embodiment, the packaging assembly comprises (a) a multilayer heat-shrinkable tube member having a total thickness of about 2.5 mils and comprising a core oxygen barrier layer, (b) a first laminate film affixed to the first tube exterior surface, the first laminate film having thickness of about 4.0 mils and comprising an ethylene-alpha-olefin co-polymer, and (c) second laminate film affixed to the second tube exterior surface, the second laminate film having a thickness of about 2.0 mils and comprising an ethylene-alpha-olefin co-polymer.

In a second embodiment, a bone-in food product storage bag is provided. Preferably, the bone-in food product storage bag comprises a heat-shrinkable tube member and a first laminate film affixed to an exterior surface of the tube member, and optionally further comprises a second laminate film affixed to an exterior surface of the tube member. Preferably, the heat shrinkable packaging is suitable for providing packages for food products with sharp edges, such as bone-in food products. Preferably, the bone-in food product storage bag is both puncture-resistant and curl-resistant when the tube member has a total free shrink at 90° C. of at least about 60%. Most preferably, the first laminate film has a total free shrink value at 90° C. of at least about 10 total free shrink value percentage points greater than the total free shrink at 90° C. of the tube member to which it is affixed.

The second embodiment can also be illustrated using FIG. 2A, FIG. 2B and FIG. 2C. A tube member can be formed by contiguously joining the first wall 402 to the second wall 452 such that the first wall 402 forms a first tube wall and the second wall 452 forms a second tube wall. The exterior surface 404 of the first wall 402 can form a first tube exterior surface; the interior surface 406 of the first wall 402 can form a first tube interior surface; the exterior surface 456 of the second wall 452 can form a second tube exterior surface; the interior surface 406 of the second wall 452 can form a second tube interior surface. The heat-shrinkable tube member can have a first tube wall joined to a second tube wall to form a product receiving chamber, the first tube wall having a first tube interior surface and a first tube exterior surface and the second tube wall having a second tube interior surface and a second tube exterior surface. The product receiving chamber can be defined by the first tube interior surface and the second tube interior surface. Preferably, the first tube exterior surface is opposable to the second tube exterior surface. Preferably, a collapsible cylindrical lumen provides a product receiving chamber defined by the first tube interior surface and the second tube interior surface. Also preferably, the first tube exterior surface is opposable to the second tube exterior surface. Also preferably, the heat-shrinkable tube member has a total free shrink value at 90° C. that is at least about 60%.

In certain preferred aspects of the second embodiment, a first tube wall and a second tube wall are formed from a single film sleeve having an interior surface and an exterior surface. Preferably, the single film sleeve is a thermoplastic film defining a collapsible cylindrical lumen. The first tube interior surface and the second tube interior surface can be contiguously joined, for example by being coextruded together, to form an interior tube member surface defining a product receiving chamber. Similarly, the first tube exterior surface and the second tube exterior surface can be contiguously joined to form an exterior tube member surface.

In a first aspect of the second embodiment, the product receiving chamber 320 can be formed from bag film 400 that is a lay-flat cylindrical tube member with edges 112 and 113, with the tube member extending along the axis 116. The tube member 400 is preferably formed by coextruding the material for the first wall 402 and the second wall 452 into a cylindrical tube member, although a tube member may also be made by folding a single sheet of material over itself or by sealing two pieces of material together. To form the product receiving chamber 320, a first seal is made along edge 114, and a cut along edge 115 produces an opening 210, which is later sealed to close the product receiving chamber 320.

In a second aspect of the second embodiment, the product receiving chamber 320 can be formed from bag film 400 that is a lay-flat cylindrical tube member with edges 114 and 115, the tube member extending laterally along the axis 118. The tube member is preferably formed by coextruding the material for the first wall 402 and the second wall 452 into a cylindrical tube member, although a tube member may also be made by folding a single sheet of material over itself or by sealing two pieces of material together. To form the product receiving chamber 320, a first seal is made along edge 112, a second seal is made along edge 113, and a cut is made along edge 115 to produce an opening 210, which is later sealed to close the product receiving chamber 320.

One or more heat-shrinkable laminate film(s) can be affixed to one or more exterior surface(s) of the tube wall(s) of the tube member to form the bone-in food product storage bag. One or more heat-shrinkable laminate film(s) can be affixed to at least a portion of the surface area of the first tube exterior surface of the first tube wall of the tube member, and preferably cover(s) a major portion of the surface area of the first tube exterior surface. Preferably, the bone-in food product storage bag comprises a first heat-shrinkable laminate film affixed to the first tube exterior surface and optionally comprises a second heat-shrinkable laminate film affixed to the second tube exterior surface. Preferably, a heat-shrinkable laminate film has a total thickness of between about 2.0 mils and 8.0 mils.

Preferably, a first exterior film sheet 300 is affixed to the outer surface of the tube member. A heat-shrinkable first exterior film sheet 300 having desirable puncture-resistant properties can form a first laminate film. The first laminate film is preferably affixed to the first tube exterior surface, which can be a first wall 402 exterior surface 404.

The first laminate film is preferably affixed to a first tube exterior surface of the first tube wall of the tube member. The first laminate film preferably has a total free shrink value at 90° C. that is at least 10 total free shrink percentage points greater than the total free shrink value at 90° C. of the tube member. The first laminate film is believed to impart curl-resistant properties to the packaging assembly and preferably provides puncture-resistant properties as well.

An optional second laminate film can be further included in the bone-in product storage bag, for example, to impart additional puncture-resistant properties to the bag. Preferably, the second laminate film is affixed to a second tube exterior surface of the second tube wall of the tube member. The first laminate film preferably has a total free shrink value at 90° C. that is at least 10 total free shrink percentage points greater than the total free shrink value at 90° C. of the second laminate film. Also preferably, the second laminate film is opposable to the first laminate film in the packaging assembly. In FIG. 2B, a second heat-shrinkable exterior film 350 having desirable puncture-resistant properties can form a second laminate film in a bone-in food product storage bag. The second laminate film is preferably affixed to the second tube exterior surface, which can be a second wall 452 exterior surface 456. Preferably, the heat-shrinkable first exterior film sheet 300 is opposable to the second heat-shrinkable exterior film 350.

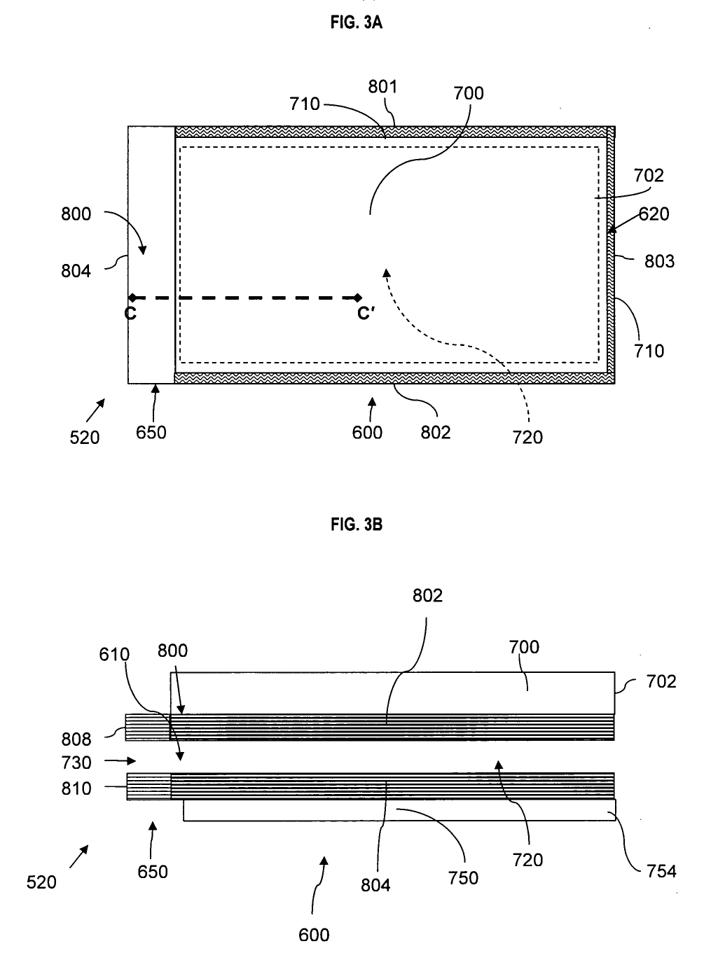

As shown as a top plan view in FIG. 3A and a corresponding cross section along line segment C-C′ shown in FIG. 3B, a bone-in food product storage bag 520 comprises a tube member 800 with a first laminate film 700 affixed to the meat side 702 of the tube member 800 and a second laminate film 750 affixed to the bone side 754 of the tube member 800.

The tube member 800 is formed from a continuous sleeve of a multilayer heat-shrinkable film. In one aspect of the second embodiment, the tube member comprises edges 803 and 804, and a product receiving chamber 720 is formed by forming a seal along edge 801 and a seal along edge 802, and cutting the tube member 800 along edge 804 to form an opening 730. The opening 730 can later be sealed to close the product receiving chamber 720 along a sealable portion 650 of the food product storage bag 520.

In another aspect of the second embodiment, the tube member comprises edges 801 and 802, and a product receiving chamber 720 is formed by forming a seal along edge 801 and a seal along edge 803, and cutting the tube member 800 along edge 804 to form an opening 730. The opening 730 can later be sealed to close the product receiving chamber 720 along a sealable portion 650 of the food product storage bag 520.

The tube member comprises a first tube wall 802 opposable to a second tube wall 804 that together define a product receiving chamber 720. One end of the product receiving chamber 620 is formed by the seal 720 that fixedly attaches the first tube wall 802 to the second tube wall 804, for example by forming an impulse heat seal or hot bar seal. The tube member 800 is a heat-shrinkable film having a total free shrink value at 90° C. that is preferably at least 10%, more preferably 60%, most preferably 80%, or greater.

In certain aspects of the second embodiment, the first laminate film 700 is affixed to the exterior surface of the first tube wall 802, which preferably corresponds to the meat side 702 of the product storage bag 520. In one aspect, the first laminate film 700 has a total free shrink value at 90° C. that is at least 10% greater than the total free shrink value at 90° C. of the tube member 800. The first laminate film 700 preferably has a total free shrink value at 90° C. that is at least 10 total free shrink percentage points, and preferably about 20, 30, 40, 50, 60, 70, 80, 90, 100 total free shrink percentage points, or any increment of 1, 0.25 or 0.1 therebetween, greater than total free shrink value at 90° C. of the tube member 800. Preferably, the tube member 800 can have any total free shrink value at 90° C. up to a maximum of about 180%. In one particularly preferred aspect of the second embodiment, the first laminate film 700 has a total free shrink value at 90° C. that is about 15-80 total free shrink percentage points, more preferably about 25-80 total free shrink percentage points, most preferably about 30-80 total free shrink percentage points greater than the total free shrink value at 90° C. of the tube member 800. In one aspect, the first laminate film 700 has a total free shrink value at 90° C. that is about 30 total free shrink percentage points, such as 29 total free shrink percentage points, greater than the total free shrink value at 90° C. of the tube member 800.

Preferably, the first laminate film 700 covers a major portion of the surface area of the external exterior surface of the first tube wall 802. For example, in one aspect, the first laminate film 700 covers the entire surface area of the first tube wall 802.

“To cover a major portion” of a surface area means to cover at least about 80%, 85%, 90%, 95%, 98% or greater of the surface area.

Also preferably, the first laminate film 700 covers at least about 80%, 85%, 90%, 95%, 98% or greater of the lateral distance across the first tube exterior surface of the first tube wall 802.

Optionally, a second laminate film 750 can be affixed to the exterior surface of the second tube wall 804, which preferably corresponds to the bone side 754 of the product storage bag 520. Preferably, the first laminate film 700 has a total free shrink value at 90° C. that is at least 10 total free shrink percentage points greater than the total free shrink value at 90° C. of the second laminate film 750.

Preferably, the second laminate film 750 covers a major portion of the surface area of the external exterior surface of the second tube wall 804. For example, in one aspect, the first laminate film 750 covers the entire surface area of the second tube wall 804.

Also preferably, the second laminate film 700 covers at least about 80%, 85%, 90%, 95%, 98% or greater of the lateral distance across the first tube exterior surface of the second tube wall 804.

The bone-in food product storage bag can optionally further comprise a heat-shrinkable tube member having a body portion. For example, FIG. 3A and FIG. 3B illustrate a bone-in food product storage bag 520 comprising a body portion 600 and a sealable portion 650. The body portion 600 can enclose the product receiving chamber 720. Preferably, the body portion 600 has an enclosed end 620 and an open end 610 before a product is sealed inside the storage bag.

The heat-shrinkable tube member 800 can further comprise a sealable portion 650 extending outwardly from the open end 610 of the body portion 600. The sealable portion 650 can have a third tube wall 808 and a fourth tube wall 810. The third tube wall 808 and the fourth tube wall 810 of the sealable portion 650 are preferably opposably positioned and define a passageway 730 continuous with the product receiving chamber 720. Preferably, the third tube wall 808 is joined to a first tube wall 802 and the fourth tube wall 810 is joined to a second tube wall 804. Also preferably, the third tube wall 808 and the fourth tube wall 810, or portions thereof, can be sealed together, for example by heat sealing, to form an enclosed product receiving chamber. Preferably, the sealable portion comprises a sealing layer.

In one particularly preferred aspect of the second embodiment, a bone-in food product storage bag comprises:

(a) a heat-shrinkable tube member having a first tube wall joined to second tube wall to form a product receiving chamber; the first tube wall having a first tube interior surface and a first tube exterior surface; the second tube wall having a second tube interior surface and a second tube exterior surface; the product receiving chamber defined by the first tube interior surface and the second tube interior surface; the first tube exterior surface opposable to the second tube exterior surface; the heat-shrinkable tube member having a total free shrink value at 90° C. of at least about 80%; where the first tube wall and the second tube wall are formed from a single multilayer film sleeve comprising a core oxygen barrier layer positioned between an interior layer defining the first tube interior surface and the second tube interior surface, and an exterior layer defining the first tube exterior surface and the second tube exterior surface; where the exterior layer and the interior layer each comprise ethylene vinyl acetate and very low density polyethylene; the oxygen barrier layer comprising PVDC;

(b) a first laminate film affixed to the first tube exterior surface and covering a major portion of the surface area of the first tube exterior surface; the first laminate film having a second total free shrink value at 90° C. of at least 90% and a thickness of about 4.0 mils; the first laminate film comprising very low density polyethylene; and

(c) a second laminate film affixed to the exterior surface of the second tube wall and covering a major portion of the surface area of the exterior surface of the second wall, the second exterior film sheet having a thickness of about 2.0 mils and having a third total free shrink value at 90° C. that is at least 10 total free shrink percentage points less than the second total free shrink value at 90° C.; the second laminate film comprising ethylene vinyl acetate and very low density polyethylene.

Preferably, bag films and tube members have a total free shrink values of at least about 50%, 55%, 60%, 65%, 70%, 75%, 80%, 85%, 90%, 95%, 100%, 105%, 110%, 115%, 120%, 125%, 130%, 135%, or 140% measured at 90° C., or any increment of 1%, 0.25% or 0.1% therebetween. Preferably, bag films and tube members have a free shrink value at 90° C. of at least 30% in at least one of the machine direction or transverse direction. The bag films and tube members preferably have a free shrink of at least 40% at 90° C. in the machine direction, the transverse direction, or in both the machine direction and the transverse direction. Preferably, the bag films and tube members have a free shrink in the machine direction of about 30%, 35%, 40%, 45%, 50%, 55%, 60%, 65% or 70% or greater, including any increment of 1%, 0.5% or 0.25% therebetween, measured at 90° C. Preferably, a bag film or a tube member has a free shrink value in the transverse direction of about 30%, 35%, 40%, 45%, 50%, 55%, 60%, 65% or 70% or greater, including any increment of 1%, 0.5% or 0.25% therebetween, measured at 90° C. More preferably, a bag film or a tube member has a free shrink value of at least 40% in two directions. Even more preferably, a bag film or a tube member has a free shrink value of at least 40% in a first direction that is the machine direction and at least 50% in a second direction that is the transverse direction.

Preferably, a bag film or a tube member has any maximum total free shrink value at 90° C. up to a maximum of about 180%, including 175%, 170%, 165%, 160%, 155%, 150%, 145%, 140%, 135%, 130%, 125%, 120%, 115%, 110%, 105%, 100%, 95%, 90%, 85%, 80%, 75%, 70%, 65%, 60%, 55%, or any increment of 1%, 0.25% or 0.1% therebetween.

More preferably, a bag film or a tube member has a total free shrink value at 90° C. of between about 50%-150%, about 60%-120%, about 70%-110%, about 80%-105%, about 60%-90%.

Preferably, first exterior film sheets and first laminate films have a total free shrink value measured at 90° C. that is greater than the total free shrink value at 90° C. of the bag films or tube members to which they are affixed. Preferably, first exterior film sheets or first laminate films can have a total free shrink value at 90° C. of at least about 60%, 65%, 70%, 75%, 80%, 85%, 90%, 95%, 100%, 105%, 110%, 115%, 120%, 125%, 130%, 135%, or 140% measured at 90° C., or any increment of 1%, 0.25% or 0.1% therebetween. Preferably, first exterior film sheets and first laminate films have any maximum total free shrink value at 90° C. up to a maximum of about 180%, including 175%, 170%, 165%, 160%, 155%, 150%, 145%, 140%, 135%, 130%, 125%, 120%, 115%, 110%, 105%, 100%, 95%, 90%, 85%, 80%, 75%, 70%, 65%, 60%, 55%, or any increment of 1%, 0.25% or 0.1% therebetween. More preferably, first exterior film sheets and first laminate films have a total free shrink value at 90° C. of between about 60%-160%, about 80%-120%, about 85%-115%, about 90%-115%, about 95%-115%, and about 100%-115%, or any numerical integer therebetween, including about 101%, 102%, 103%, 104%, 105%, 106%, 107%, 108%, 109%, 110%, 111%, 112%, or 114%.

Preferably, second exterior film sheets or second laminate films have a total free shrink value measured at 90° C. that is less than the total free shrink value at 90° C. of the first exterior film sheets or first laminate films, respectively. The second exterior film sheets and second laminate films preferably have a total free shrink value measured at 90° C. that is greater than the tube members to which they are affixed, though some aspects provide second exterior film sheets and second laminate films having about the same, or lower, total free shrink value as the bag films or tube members to which they are attached. Second exterior film sheets or second laminate films can have a total free shrink value at 90° C. of at least about 50%, 55%, 60%, 65%, 70%, 75%, 80%, 85%, 90%, 95%, 100%, 105%, 110%, 115%, 120%, 125%, 130%, 135%, or 140% measured at 90° C., or any increment of 1%, 0.25% or 0.1% therebetween. Preferably, second exterior film sheets and second laminate films have any suitable maximum total free shrink value at 90° C. up to a maximum of about 180%, including 175%, 170%, 165%, 160%, 155%, 150%, 145%, 140%, 135%, 130%, 125%, 120%, 115%, 110%, 105%, 100%, 95%, 90%, 85%, 80%, 75%, 70%, 65%, 60%, 55%, or any increment of 1%, 0.25% or 0.1% therebetween. More preferably, second exterior film sheets and second laminate films have a total free shrink value at 90° C. of between about 50%-150%, about 80%-120%, about 85%-115%, about 90%-115%, about 95%-115%, and about 100%-115%, or any numerical integer therebetween, or about 110%.

In some aspects, the first laminate film or the first exterior film sheet has a shrink force value that is greater than the shrink force value of the bag film or tube member, respectively, to which it is attached. Preferably, the shrink force value is measured in one of the machine direction (MD) or the transverse direction (TD) at 90° C., although the shrink force can be measured at any suitable temperature, including 100° C. More preferably, the first laminate film or the first exterior film sheet has a shrink force value that is greater in at least one of the (MD) or the (TD) than the shrink force value of the bag film or tube member, respectively, to which it is attached. Most preferably, the first laminate film or the first exterior film sheet has a shrink force value that is greater in both the (MD) and the (TD) than the shrink force value of the bag film or tube member, respectively, to which it is attached.

In one aspect, a first laminate film or first exterior film sheet has a shrink force value in the (MD) measured at 90° C. that is greater than the corresponding shrink force value in the (MD) measured at 90° C. for the bag film or tube member, respectively, to which it is attached. Preferably, a bag film or tube member has a shrink force value in the (MD) measured at 90° C. that is about 15%, 20%, 25%, 30%, 35%, 40%, 45%, 50%, 55%, 60%, 65%, or any increment of 1%, 0.25% or 0.1 therebetween, of the corresponding shrink force value in the (MD) measured at 90° C. for a first laminate film or a first exterior film sheet attached to the bag film or tube member, respectively. For example, in one aspect, the shrink force in the (MD) of a tube film is about 40%, such as 40.0%, of the shrink force in the (MD) of the first laminate film to which it is affixed.

In another aspect, a first laminate film or first exterior film sheet has a shrink force value in the (TD) measured at 90° C. that is greater than the corresponding shrink force value in the (TD) measured at 90° C. for the bag film or tube member, respectively, to which it is attached. Preferably, a bag film or tube member has a shrink force value in the (MD) measured at 90° C. that is about 15%, 20%, 25%, 30%, 35%, 40%, 45%, 50%, 55%, 60%, 65%, or any increment of 1%, 0.25% or 0.1 therebetween, of the corresponding shrink force value in the (MD) measured at 90° C. for a first laminate film or a first exterior film sheet attached to the bag film or tube member, respectively. For example, in one aspect, the shrink force in the (MD) of a tube film is about 40%, such as 36.8%, of the shrink force in the (MD) of the first laminate film to which it is affixed.

In one aspect, a second laminate film or second exterior film sheet has a shrink force value in the (MD) measured at 90° C. that is greater than the corresponding shrink force value in the (MD) measured at 90° C. for the bag film or tube member, respectively, to which it is attached. Preferably, a bag film or tube member has a shrink force value in the (MD) measured at 90° C. that is about 35%, 40%, 45%, 50%, 55%, 60%, 65%, 70%, 75%, 80%, 85%, or any increment of 1%, 0.25% or 0.1 therebetween, of the corresponding shrink force value in the (MD) measured at 90° C. for a second laminate film or a second exterior film sheet attached to the bag film or tube member, respectively. For example, in one aspect, the shrink force in the (MD) of a tube film is about 60%, such as 58.7%, of the shrink force in the (MD) of the second laminate film to which it is affixed.

In one aspect, a second laminate film or second exterior film sheet has a shrink force value in the (TD) measured at 90° C. that is greater than the corresponding shrink force value in the (TD) measured at 90° C. for the bag film or tube member, respectively, to which it is attached. Preferably, a bag film or tube member has a shrink force value in the (TD) measured at 90° C. that is about 25%, 30%, 35%, 40%, 45%, 50%, 55%, 60%, 65%, 70%, 75%, or any increment of 1%, 0.25% or 0.1 therebetween, of the corresponding shrink force value in the (TD) measured at 90° C. for a second laminate film or a second exterior film sheet attached to the bag film or tube member, respectively. For example, in one aspect, the shrink force in the (TD) of a tube film is about 55%, such as 53.3%, of the shrink force in the (TD) of the second laminate film to which it is affixed.

In some aspects, the first laminate film or the first exterior film sheet has a shrink force value that is greater than the shrink force value of the second laminate film or the second exterior film sheet, respectively. Preferably, the shrink force value is measured in one of the machine direction (MD) or the transverse direction (TD) at 90° C., although the shrink force can be measured at any suitable temperature, including 100° C. More preferably, the first laminate film or the first exterior film sheet has a shrink force value that is greater in at least one of the (MD) or the (TD) than the second laminate film or the second exterior film sheet, respectively. Most preferably, the first laminate film or the first exterior film sheet has a shrink force value that is greater in both the (MD) and the (TD) than the shrink force value of the second laminate film or the second exterior film sheet, respectively.

In one aspect, a first laminate film or first exterior film sheet has a shrink force value in the (MD) measured at 90° C. that is greater than the corresponding shrink force value in the (MD) measured at 90° C. for second laminate film or the second exterior film sheet, respectively. Preferably, a second laminate film or a second exterior film sheet has a shrink force value in the (MD) measured at 90° C that is about 35%, 40%, 45%, 50%, 55%, 60%, 65%, 70%, 75%, 80%, 85%, or any increment of 1%, 0.25% or 0.1 therebetween, of the corresponding shrink force value in the (MD) measured at 90° C. for a first laminate film or a first exterior film sheet, respectively. For example, in one aspect, the shrink force in the (MD) of a second laminate film is about 65%, such as 65.7%, of the shrink force in the (MD) of the first laminate film.

In one aspect, a first laminate film or first exterior film sheet has a shrink force value in the (TD) measured at 90° C. that is greater than the corresponding shrink force value in the (TD) measured at 90° C. for second laminate film or the second exterior film sheet, respectively. Preferably, a second laminate film or a second exterior film sheet has a shrink force value in the (TD) measured at 90° C. that is about 35%, 40%, 45%, 50%, 55%, 60%, 65%, 70%, 75%, 80%, 85%, or any increment of 1%, 0.25% or 0.1 therebetween, of the corresponding shrink force value in the (TD) measured at 90° C. for a first laminate film or a first exterior film sheet, respectively. For example, in one aspect, the shrink force in the (TD) of a second laminate film is about 70%, such as 70.0%, of the shrink force in the (TD) of the first laminate film.

The bag films or tube members can be formed from any suitable heat-shrinkable film, and can be single-layer or multilayer films. The bag films and tube members are preferably multilayer films having two to fourteen layers. More preferably, bag films and tube members comprise a composition suited for their intended purpose. Most preferably, a bag film or a tube member comprises a barrier layer, such as an oxygen barrier layer.

In some aspects comprising a heat-shrinkable packaging assembly, the first tube wall and a second tube wall can be formed from a single film sleeve having an interior surface and an exterior surface. Preferably, the film sleeve is a multilayer film. The single multilayer film sleeve can comprise a core oxygen barrier layer positioned between an interior layer defining an interior tube member surface and an exterior layer defining an exterior tube member surface. The interior or exterior layers preferably comprise one or more polymers selected from the group consisting of ethylene vinyl acetate, very low density polyethylene, and blends or copolymers thereof.

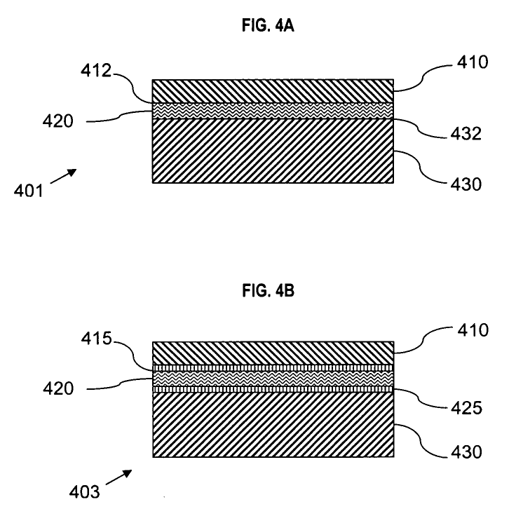

Some aspects provide a three-layer coextruded film with desirable levels of heat shrinkability in a multilayer film structure. Referring to FIG. 4A, a cross section of a three-layer film structure is provided that is useful as either a bag film or a tube member. The three-layer film 401 comprises a core barrier layer 420 that is joined to an exterior layer 410 at a first interface 412, and joined to an interior layer 430 at a second interface 432. Preferably, the core barrier layer 420 is an oxygen barrier layer, but can also be a moisture barrier layer, or both.

Some aspects provide a five-layer coextruded film with desirable levels of heat shrinkability in a multilayer film structure. Referring specifically to FIG. 4B, a cross section of a five-layer film structure is provided that is useful as either a bag film or a tube member. The five-layer film 403 comprises successively joined layers: an interior layer 430, a second adhesive (tie) layer 425, a core barrier layer 420, a first adhesive (tie) layer 415, and an exterior layer 410. Preferably, the core barrier layer 420 is an oxygen barrier layer, but can also be a moisture barrier layer, or both.

In another aspect of the first embodiment, the packaging assembly 110 shown in FIG. 2A and FIG. 2B comprises bag film 400 that is a multilayer film illustrated in FIG. 4A. In one aspect, the bag film 400 comprises a first wall 402 and a second wall 454 (FIG. 2B) that are both made from a three-layer film 401 (FIG. 4A). Referring to FIG. 4A, the three-layer film 401 comprises a core barrier layer 420 that is joined to an exterior layer 410 at a first interface 412, and joined to an interior layer 430 at a second interface 432. Preferably, the core barrier layer 420 is an oxygen barrier layer, but can also be a moisture barrier layer, or both. Substituting the three-layer film 401 (FIG. 4A) for the bag film 400 in the packaging assembly 110 in FIG. 2A, the exterior layer 410 (FIG. 4A) can form the exterior surface 404 of the first film wall 402 or the exterior surface 456 of the second film wall 450. The first interface 412 and the second interface 432 portions of the multilayer film of FIG. 4A can be replaced with adhesive layers to form a five-layer film 403 in FIG. 4B. The five-layer film 403 in FIG. 4B comprises a first adhesive layer 415 and a second adhesive layer 425, respectively, to promote adhesion to the core barrier layer 420 in addition to the interior layer.

Examples of suitable multilayer films for a bag film or a tube member can be selected from the films disclosed in U.S. Pat. Nos. 6,815,023 (Tatarka et al.) entitled “Puncture Resistant Polymeric Films, Blends and Process” and assigned to Curwood, Inc.; U.S. Pat. No. 6,749,910 (Geogelos et al.) entitled “Bag for Bone-In Meat Packing” and assigned to Curwood, Inc.; U.S. Pat. No. 6,777,046 (Tatarka et al.) entitled “Puncture Resistant, High Shrink Films, Blends and Process” and assigned to Curwood Inc.; and U.S. Pat. No. 5,928,740 (Wilhoit et al.) entitled “Thermoplastic C₂-α-olefln Copolymer Blends and Films” and assigned on its face to Viskase Corporation; all of which are incorporated herein by reference in their entirety.

In a third embodiment, a laminate bag is provided comprising: a heat-shrinkable bag having an exterior surface and an interior surface, the interior surface defining a product receiving chamber, and a first heat-shrinkable laminate affixed to the exterior surface. Preferably, the heat-shrinkable bag can comprise any bag film or tube member, or any combination thereof. Also preferably, the first heat-shrinkable laminate comprises any heat-shrinkable first exterior film sheet or first laminate film.

Preferably, the laminate bag has a total free shrink value at 90° C. of between about 60% and 180%. Also preferably, the heat-shrinkable laminate has a total free shrink value at 90° C. of between about 90% and 180%. The total free shrink value at 90° C. of the heat-shrinkable laminate is preferably at least 40 total free shrink percentage points greater than the total free shrink value at 90° C. of the heat-shrinkable bag. In one aspect, the total free shrink value at 90° C. of the heat-shrinkable laminate is at least 60 total free shrink percentage points greater than the total free shrink value at 90° C. of the heat-shrinkable bag. In another aspect, the total free shrink value at 90° C. of the heat-shrinkable laminate is at least 80 total free shrink percentage points greater than the total free shrink value at 90° C. of the heat-shrinkable bag. In another aspect, the exterior surface comprises a first exterior surface opposable to a second exterior surface; the heat-shrinkable laminate can be a first heat-shrinkable laminate attached to the first exterior surface.

The laminate bag can optionally further comprise a second heat-shrinkable laminate attached to the second exterior surface. Preferably, the second heat-shrinkable laminate has a total free shrink value at 90° C. of between about 60% and 180%. Also preferably, the total free shrink value at 90° C. of the first heat-shrinkable laminate is at least 30 total free shrink percentage points greater than the total free shrink value at 90° C. of the second heat-shrinkable laminate.

Preferably, a bag film or a tube member has a total thickness of less than about 20 mils. The bag film or the tube member can be a single or multilayer film. A single layer film or any single layer of a multilayer film in the bag film or the tube member can have any suitable thicknesses, including 1, 2, 3, 4, 5, 6, 7, 8, 9, 10, 11, 12, 13, 14, 15, 16, 17, 18, 19, or 20 mils, or any increment of 0.1 or 0.01 mil therebetween. Preferred bag film or tube member thicknesses are about 2.00, 2.25, 2.50, 2.75, 3.00, 3.25, 3.50, 3.75, 4.00, 4.25, 4.50, 4.75, 5.00, 5.25, 5.50, 6.00, 6.25, 6.50 and 6.75 mils, and particularly preferably about 2.25 mils, 2.50 mils or 2.75 mils. Bag films and tube members comprising thicker and thinner films are also provided. Bag films and tube member films preferably have a thickness of about 2-3 mils (50.8-76.2 microns), although suitable films for packaging foodstuffs as thick as 4 mils (101.6 microns) or as thin as 1 mil (25.4 microns) may be made. Typically, films will be between about 1.5-3 mil (38.1-76.2 microns). Especially preferred for use as films for food packaging are films where a multilayer film has a thickness of between about 2 to 3 mils (50.8-76.2 microns). Such films can have good abuse resistance and machinability. Preferred films are heat shrinkable and have a desirable level of total heat shrinkage measured at 90° C. Preferred films may also provide a beneficial combination of one or more or all of the properties including low haze, high gloss, high shrinkage values at 90° C. or less, good machinability, good mechanical strength and good barrier properties including high barriers to oxygen and water permeability. Preferred materials for film sheets and laminate films are heat-shrinkable, adhere to a bag film or a tube member and provide enhanced puncture resistance.

Preferably, an external film sheet or a laminate film has a total thickness of less than about 20 mils. The external film sheet or laminate film can be a single film or a multilayer film. A single layer film or any single layer of a multilayer film in the external film sheet or the laminate film can have any suitable thicknesses, including 1, 2, 3, 4, 5, 6, 7, 8, 9, 10, 11, 12, 13, 14, 15, 16, 17, 18, 19, or 20 mils, or any increment of 0.1 or 0.01 mil therebetween. Preferred external film sheet or laminate film thicknesses are about 2.00, 2.25, 2.50, 2.75, 3.00, 3.25, 3.50, 3.75, 4.00, 4.25, 4.50, 4.75, 5.00, 5.25, 5.50, 6.00, 6.25, 6.50 and 6.75 mils. Particularly preferred first external film sheet or first laminate films have thicknesses of about 4.00 mils to about 6.75 mils. Particularly preferred second external film sheet or second laminate films have thicknesses of about 2.00 mils, 2.25 mils or 2.50 mils.

A bag film, an exterior film sheet, a tube member or a laminate film can be independently formed from any suitable material or combination of materials, and can independently comprise any suitable single or multilayer film. Suitable materials are those that provide desirable properties of heat shrinkability, and are optionally puncture-resistant. In some aspects, suitable materials include certain thermoplastic polymers, such as polyolefin (e.g., linear low-density polyethylene, very low-density polyethylene, homogeneous polymers such as metallocene catalyzed ethylene/alpha-olefin copolymer, etc.), polyamide, polyester (e.g., polyethylene terephthalate glycol), ethylene/ester copolymer (e.g., ethylene/vinyl acetate copolymer), ionomers, and functional equivalents thereof.

Preferably, a bag film, an exterior film sheet, a tube member or a laminate film comprise an ethylene-alpha-olefin copolymer (EAOs). EAOs are copolymers predominantly comprising at least 50% and preferably about 80% or more of ethylene polymeric units copolymerized with less than 50%, more preferably less than 80%, by weight of one or more suitable alpha-olefins which include C₃ to C₁₀ alpha-olefins such as propene, butene-1, pentene-1, hexene-1, methylpentene-1, octene-1, decene-1. Preferred alpha-olefins are butane-1, hexene-1 and octene-1, and particularly preferred alpha-olefins are hexene-1 and octene-1.

Suitable EAO copolymers include, but are not limited to, LLDPE and VLDPE. LLDPE, or linear low-density polyethylene, is a class of EAO copolymers having a density greater than 0.915 g/cm³. VLDPE, also called ultra low density polyethylene (ULDPE), is a class of EAO copolymers having a density less than 0.915 g/cm³ and many commercial VLDPE resins are available having densities from 0.900 up to 0.915 g/cm³. Plastomers are generally EAOs having densities below 0.900 g/cm³.

In some aspects, a bag film, an exterior film sheet, a tube member or a laminate film comprise a blend of at least one ethylene-alpha-olefin copolymer, with an ethylene vinyl acetate co-polymer (EVA). Any suitable EVA co-polymer can be used. Preferably, the EVA comprises about 5%—about 50% VA, more preferably about 5% to about 15% VA and most preferably the EVA comprises about 10% to about 12% VA, including any increment of 1%, 0.1% or 0.01% VA in between. For example, EVA with 10.0% VA or 10.5% VA can be used in some aspects.

Preferred compositions for forming one or more layers of a bag film, an exterior film sheet, a tube member or a laminate film comprise a VLDPE, a plastomer and an EVA co-polymer. Where the bag film or the tube member are multilayer films, the interior and exterior layers, which can be the same or different, preferably comprise a VLDPE, a plastomer and an EVA co-polymer.

In one aspect, the interior layer of a multilayer bag film or tube member comprises between about 10% to about 50% EVA, more preferably about 20% to about 35%, and most preferably about 25% to about 30% of EVA. Preferably, the interior layer also comprises about 10% to about 95%, more preferably about 60% to about 85%, and most preferably about 70% to about 75% VLDPE. In one preferred aspect, the interior layer of a multilayer bag film or tube member comprises about 20%-25% EVA (10.5% VA), and about 70%-75% VLDPE.

Preferably, the interior layer of a multilayer bag film or tube member, or a portion of an interior layer, is a sealant layer. In one aspect, a seal portion of a bag film or a tube member comprises a sealant layer. In another aspect, a sealant layer forms at least a portion of the surface of a product receiving chamber.

As used herein, the phrases “seal layer,” “sealing layer,” “heat seal layer,” and “sealant layer,” refer to a film layer, or layers, involved in the sealing of the film to itself, another film layer of the same or another film, and/or another article which is not a film. The inside layer frequently also serves as a food contact layer in the packaging of foods. In one aspect, the interior layer of a multilayer bag film or tube member is a heat sealing layer. Preferably, the sealant layer is an interior surface heat sealing layer which allows the film to be formed into bags. Preferably, a sealant layer can form about 5 to 50% of the thickness of the total structure with a preferred thickness being about 15% of the total thickness.

A sealant layer preferably comprises a heat sealable polymeric material such as an ethylene alpha olefin copolymer and vinyl esters or alkyl acrylates, such as vinyl acetate. Other suitable sealant materials include metallocene catalyzed polyolefins, polyolefins, ethylene-alpha olefin copolymers, and blends thereof. Preferably, the heat sealing layers comprise a blend of at least one ethylene-alpha-olefin copolymer (EAO), with ethylene vinyl acetate (EAO:EVA blend). A sealant layer also preferably further comprises an ionomer such as Surlyn®, available from DuPont Company. This ionomer material is essentially a metal salt neutralized copolymer of ethylene and acrylic or methacrylic acid. Suitable compositions for forming a heat sealing layer are disclosed in Published U.S. patent application Ser. No. US2004/0043167A1, Holzem et al., which is incorporated by reference herein in its entirety. Heat-shrinkable films are also discussed in U.S. Pat. No. 5,403,668, also incorporated herein by reference in its entirety.

In one aspect, the exterior layer of a multilayer bag film or tube member comprises between about 10% to about 50% EVA, more preferably about 20% to about 35%, and most preferably about 25% to about 30% of EVA. Preferably, the exterior layer also comprises about 10% to about 95%, more preferably about 20% to about 35%, and most preferably about 25% to about 30% VLDPE. In one aspect, an exterior layer further comprises about 10% to about 80% plastomer, more preferably about 25% to about 65% plastomer, and most preferably about 40% to about 50% plastomer, including about 45% plastomer. In one preferred aspect, the exterior layer of a multilayer bag film or tube member comprises about 45% plastomer, about 25%-30% EVA (10.5% VA), and about 25% VLDPE.

Various additives may be included in one or more layers of a bag film, an exterior film sheet, a tube member or a laminate film. For example, a layer may be coated with an anti-block powder. Also, conventional antiblock additives, polymeric plasticizers, acid scavengers or slip agents may be added to one or more layers of the film or it may be free from such added ingredients. Processing aids are typically used in amounts less than 10%, less than 7% and preferably less than 5% of the layer weight. A preferred processing aid for use in the exterior layer of the film includes one or more of fluoroelastomers, stearamides, erucamides, and silicates.

Preferably, a processing/slip aid can be added to one or more layers of a bag film, an exterior film sheet, a tube member or a laminate film. For example, up to about 10% or more of a processing aid, including about 9%, 8%, 7%, 6%, 5%, 4%, 3%, 2% or 1%, and most preferably about 3% of a processing/slip aid can be added to an interior or exterior layer in the three-layer film. Examples of suitable processing/slip aid concentrates include (2.25/2.5)(Oleamide) concentrates such as Ampacet 501582-A and Spartech A27050. Preferably, a stabilizer such as Spartech A32434 VLDPE Stabilizer or Ampacet 501234 VLDPE Stabilizer is also added to one or more layers. Preferably, up to 5% or more of a stabilizer, including about 4%, 3%, 2% or 1 %, and most preferably about 3% of a processing/slip aid can be added to an interior or exterior layer in the three-layer film.

In some aspects, the multilayer films used as bag films or tube members preferably comprise a barrier layer, which is preferably an oxygen barrier layer. The barrier layer can provide an oxygen barrier, a moisture barrier layer, or both properties, for preservation of the article to be packaged. An oxygen barrier layer is preferably positioned between the first and second layers. For example, the oxygen barrier layer can be in contact with the first layer and an adhesive layer. In some aspects, the film, bag, process and package provided herein comprise heat-sealable, oxygen- or moisture-barrier films for holding a foodstuff during cooking and/or for packaging for sale of such a foodstuff after a pasteurization or cooking period.

The barrier layer can also provide good optical properties when stretch-oriented, including low haze and a stretching behavior compatible with the layers around it. It is desirable that the thickness of the core layer be less than about 0.45 mil (10.16 microns) and greater than about 0.05 mil (1.27 microns) to provide the desired combination of the performance properties sought, e.g. with respect to oxygen permeability, shrinkage values especially at low temperatures, ease of orientation, delamination resistance, and optical properties. Suitable thicknesses are less than 15%, e.g. from 3 to 13% of the total film thickness. Preferably, the thickness of the core layer will also be less than about 10% of the total thickness of the multilayer film.

A barrier layer can comprise any suitable material. An oxygen-barrier layer is formed of any suitable oxygen barrier material or blend of material, for example, ethylene-vinyl alcohol copolymer (EVOH) or vinylidene chloride copolymers (VDC) such as VDC-vinyl chloride (VDC-VC) or VDC-methylacrylate (VDC-MA). Preferably, the barrier layer is an oxygen-barrier layer comprising a 5.5:1 blend of vinylidene chloride-methylacrylate copolymer and vinylidene chloride-vinyl chloride copolymer and a minor amount (about 2-3%) of conventional plasticizing, lubricating and/or coloring additives such as ultramarine blue, see e.g. U.S. Pat. Nos. 4,798,751 and 6,815,023 which are both hereby incorporated by reference in their entirety.

The oxygen barrier layer preferably forms a relatively small percentage of total film thickness, such as less than 10%. For perishable food packaging, the oxygen (O₂) permeability desirably should be minimized. Suitable films may have an O₂ permeability of less than about 20 cm³/m² for a 24 hour period at 1 atmosphere, 0% relative humidity and 23° C., and preferably less than 15 cm³/m², more preferably less than 10 cm³/m². The amount of MA-Saran in the core layer may be adjusted by blending in compatible polymers to vary orientation parameters or the gas permeability e.g. O₂ of the films. The thickness of the core layer may also be varied, preferably from about 0.05 to about 0.30 mils (1.3-7.62 microns).

In other embodiments, an EVOH material is used as an oxygen barrier layer. An oxygen barrier layer can comprise a hydrolyzed ethylene/vinyl acetate copolymer (designated by the abbreviations “EVOH” and “HEVA,” and also referred to as “ethylene/vinyl alcohol copolymer”), polyvinylidene chloride, polyamide, polyester, polyalkylene carbonate, polyacrylonitrile, and the like.

In a fourth embodiment, methods of forming a food storage bag are provided. Preferably, the methods comprise one or more of the following steps, in any suitable order:

(a) providing a continuous heat-shrinkable tube film having a first tube wall and an opposed second tube wall; the first tube wall and the second tube wall together defining an interior tube surface and an exterior tube surface; the heat-shrinkable tube having a first total free shrink value at 90° C.; or

(b) affixing a first laminate film to the exterior tube surface of the first tube wall and optionally covering a major portion of the surface area of the exterior surface of the first tube wall; the first laminate film having a second total free shrink value at 90° C. is at least 10 total free shrink percentage points greater than the first total free shrink value at 90° C.

The addition of other steps between any steps recited herein is also within the scope of this embodiment.

In one preferred aspect of the fourth embodiment, methods of forming a food storage bag comprise one or more of the following steps, in any suitable order:

(c) affixing a second laminate film to the exterior surface of the second tube wall and covering a major portion of the surface area of the exterior surface of the second wall, the second exterior film sheet having a third total free shrink value at 90° C.; where the second total free shrink value at 90° C. is at least 10 total free shrink percentage points greater than the third total free shrink value at 90° C.;

(d) providing a first lateral seal through the first tube wall and the second tube wall, the first lateral seal extending laterally across the width of the tube; or

(e) providing a cut laterally through the first tube wall and the second tube wall, the cut extending laterally across at least the width of the first laminate film and the second laminate film. Preferably, in this aspect of the fourth embodiment, the steps are carried out in alphabetical order starting with step (a) and ending with step (e), although other steps may be added at any point in the method, and any suitable order of steps is within the scope of this embodiment.

In another preferred aspect of the fourth embodiment, methods of forming a food storage bag comprise one or more of the following steps, in any suitable order:

(c) affixing a second laminate film to the exterior surface of the second tube wall and covering a major portion of the surface area of the exterior surface of the second wall, the second exterior film sheet having a third total free shrink value at 90° C. that is at least 10 total free shrink percentage points less than the second total free shrink value;

(d) providing a first lateral seal through the first tube wall and the second tube wall, the first lateral seal extending laterally across the width of the tube;

(e) providing a second lateral seal through the first tube wall and the second tube wall, the second lateral seal extending laterally across the width of the tube; the second lateral seal being substantially parallel to the first lateral seal and the second lateral seal being positioned at a first distance from the first lateral seal, the first distance measured along the longitudinal axis of the tube film; and

(f) providing a cut laterally through the first tube wall and the second tube wall substantially perpendicular to the first lateral seal, the cut extending laterally across at least first distance between the first lateral seal and the second lateral seal. Preferably, in this aspect of the fourth embodiment, the steps are carried out in alphabetical order starting with step (a) and ending with step (f), although other steps may be added at any point in the method, and any suitable order is within the scope of this embodiment.

Preferably, bag films or tube members are prepared by coextrusion as a primary tube, which is cooled upon exiting the die by spraying with tap water. This primary tube can then be reheated by radiant heaters with further heating to the draw temperature (also called the orientation temperature) for biaxial orientation accomplished by an air cushion which is itself heated by transverse flow through a heated porous tube that is concentrically positioned around the moving primary tube. Cooling is accomplished by means of a concentric air ring.

In a preferred process for making films, the resins and any additives are introduced to an extruder (generally one extruder per layer) where the resins are melt-plastified by heating and then are transferred to an extrusion (or coextrusion) die for formation into a tube. Extruder and die temperatures will generally depend upon the particular resin or resin containing mixtures being processed and suitable temperature ranges for commercially available resins that are generally known in the art, or are provided in technical bulletins made available by resin manufacturers. Processing temperatures may vary depending upon other process parameters chosen. However, variations are expected which may depend upon such factors as variation of polymer resin selection, use of other resins e.g. by blending or in separate layers in the multilayer film, the manufacturing process used and particular equipment and other process parameters utilized. Actual process parameters including process temperatures are expected to be set by one skilled in the art without undue experimentation in view of the present disclosure.

As generally recognized in the art, resin properties may be further modified by blending two or more resins together and it is contemplated that various resins may be blended into individual layers of the multilayer film or added as additional layers, such resins include ethylene-unsaturated ester copolymer resins, especially vinyl ester copolymers such as EVAs, or other ester polymers, very low density polyethylene (VLDPE), linear low density polyethylene (LLDPE), low density polyethylene (LDPE), high density polyethylene (HDPE), nylons, ionomers, polypropylenes, or blends thereof. These resins and others may be mixed by well known methods using commercially available tumblers, mixers or blenders. Also, if desired, well known additives such as processing aids, slip agents, antiblocking agents, pigments, etc., and mixtures thereof may be incorporated into the film. Examples of suitable processing/slip aid concentrates include (2.25/2.5)(Oleamide) concentrates such as Ampacet 501582-A and Spartech A27050. Examples of a stabilizers include Spartech A32434 VLDPE Stabilizer or Ampacet 501234 VLDPE Stabilizer.

Various polymer modifiers may be incorporated for the purpose of improving toughness and/or orientability or extensibility of the film. Other modifiers which may be added include: modifiers which improve low temperature toughness or impact strength, and modifiers which reduce modulus or stiffness. Exemplary modifiers include: styrene-butadiene, styrene-isoprene, and ethylene-propylene.

Preferably, the tube member or bag film is irradiated to induce crosslinking. In the irradiation process, the film is subjected to an energetic radiation treatment, such as corona discharge, plasma, flame, ultraviolet, X-ray, gamma ray, beta ray, and high energy electron treatment, which induce cross-linking between molecules of the irradiated material. The irradiation of polymeric films is disclosed in U.S. Pat. No. 4,064,296, to BORNSTEIN, et. al., which is hereby incorporated in its entirety, by reference thereto. BORNSTEIN, et. al. discloses the use of ionizing radiation for crosslinking the polymer present in the film. In some preferred embodiments, it is preferred to crosslink the entire film to broaden the heat sealing range. This is preferably done by irradiation with an electron beam at dosage levels of at least about 2 megarads (MR) and preferably in the range of 3 to 8 MR, although higher dosages may be employed. Irradiation may be done on the primary tube or after biaxial orientation. The latter, called post-irradiation, is preferred and described in U.S. Pat. No. 4,737,391 (Lustig et al.). An advantage of post-irradiation is that a relatively thin film is treated instead of the relatively thick primary tube, thereby reducing the power requirement for a given treatment level.

Alternatively, crosslinking may be achieved by addition of a chemical crosslinking agent or by use of irradiation in combination with a crosslinking enhancer added to one or more of the layers, as for example described in U.S. Pat. No. 4,055,328 (Evert et al.). The most commonly used cross-linking enhancers are organic peroxides such as trimethylpropane and trimethylacrylate.

Any suitable structure or method can be used to affix an exterior film sheet to a bag film, or to affix a laminate film to a tube member. Suitable structures and methods allow for a desirable level of adhesion between the exterior film sheet and a surface of the bag film, or between a laminate film and a surface of a tube member, without substantial delamination anticipated conditions of use.

Preferably, a surface of the bag film or tube member, a surface of a film sheet or a laminate film, or any combination of these surfaces, are surface treated by a high energy source to promote adhesion of the film sheet or laminate film to a bag film or tube member, respectively. Suitable high energy sources include exposure to any source of energy that promotes or enhances adhesion between the surfaces after treatment. Examples of high energy sources include corona discharge, flame, plasma and ultraviolet treatment, and, in general, treatments which expose the surfaces to energetic radiation in the presence of gas such as oxygen or nitrogen. Corona discharge is the most preferred high energy to film surface transfer method, and preferably in the range of about 44 to 46 dynes/cm wetting tension. Without being limited to theory, it is believed that higher surface energies do not appear necessary to achieve a desirable level strong adhesion between the film sheet and a bag film, or between a laminate film and a tube member.

Preferred examples of high energy treatment methods are disclosed in U.S. Pat. Nos. 5,302,402 and 5,376,394, which are incorporated herein by reference in their entirety. Briefly, these preferred high energy sources impart wetting tension of at least about 38 dynes/cm to these surfaces. The term “wetting tension” refers to a measure of the surface energy of a film in accordance with the test described in ASTM D2578-84. Corona treatment can be performed, for example, by a covered roll multiple electrode treater using apparatus identified by a manufacturer such as Pillar Company of Hartland, Wis. as Model AB 1326-1A. Other corona treatment devices may also be used. Corona treatment may also be done with bare roll type apparatus.

Of general interest concerning adhering surface treatment of polymeric materials is the representative disclosure of Bonet U.S. Pat. No. 4,120,716 directed to improvement of adherence characteristics of the surface of polyethylene by corona treatment to oxidize the polyethylene surface to promote wetting by printing inks and adhesives, and is incorporated herein by reference in its entirety. Of general interest concerning flame surface treatment of polymeric film is the representative disclosure of Lonkowsky U.S. Pat. No. 2,767,103. Of general interest concerning ultra violet surface treatment of polymeric film is the representative disclosure of Wolinski U.S. Pat. No. 3,227,605, both of which are incorporated herein by reference in their entirety. Of general interest concerning plasma surface treatment of polymeric film is the disclosure of Baird et al. U.S. Pat. No. 3,870,610, which is also incorporated herein by reference in its entirety.

In addition to, or as an alternative to, corona treatment of one or more surfaces, various structures can be included in a packaging assembly or bone-in food product storage bag to affix a film sheet or laminate film, respectively. One suitable structure is an adhesive or adhesive tie layer positioned between an exterior film sheet and a bag film or between a laminate film and a tube member surface. In some aspects, one or more adhesive layers may be included between a heat-shrinkable exterior film sheet and the exterior surface of a bag film wall, or between the exterior surface of a tube member and a laminate film. The food packages can further include an oxygen barrier layer positioned between an exterior surface layer and the interior surface layer, optionally in contact with the first adhesive layer, the exterior layer or both. A bag film or a tube member can also comprise multilayer films having one or more adhesive layers, also known in the art as “tie layers” within the multilayer film. An adhesive layer can join together adjacent layers in a multilayer film. In some aspects, adhesive layers comprise materials found in both the interior and exterior layers of multilayer films. The adhesive layer is preferably between 2% and 10% of the overall thickness of the multilayer film, preferably 3%. The adhesive layer is believed to aid in the adherence of the first layer to the second layer by virtue of the compatibility of the materials in that layer to the first and second layers.

In some aspects, the heat-shrinkable food package can further comprise a sealant layer positioned at or near the interior surface of the package, for example as an interior layer. A first adhesive layer may also be included between a heat resistant exterior layer and the interior layer. The food packages can further include an oxygen barrier layer positioned between an exterior layer and the interior layer, optionally in contact with the first adhesive layer, the exterior layer or both. In some aspects, the heat-shrinkable food package can be a cook-in package, preferably when the food package comprises a sealant layer formed from a material that is compatible with cooking conditions.

### EXAMPLES

Experimental results and reported properties of the following examples are based on the following test methods or substantially similar test methods unless noted otherwise.

Gauge: ASTM D-2103

Melt Index: ASTM D-1238, Condition E (190° C.) (except for propene-based (>50% C₃ content) polymers tested at Condition TL(230° C.))

Shrinkage Values: Measuring the unrestrained shrink value of a thermoplastic film is accomplished by a procedure derived from ASTM D2732. In this procedure, four test specimens are cut from a given sample of the film to be tested. Shrinkage values are defined to be values obtained by measuring unrestrained shrink of a 10 cm square sample immersed in water at 90° C. (or the indicated temperature if different) for five seconds. The four test specimens are cut into squares of 10 cm length in the machine direction by 10 cm length in the transverse direction. Each specimen is completely immersed for 5 seconds in a 90° C. (or the indicated temperature if different) water bath. The specimen is then removed from the bath and the distance between the ends of the shrunken specimen is measured for both the machine direction (M.D.) and transverse direction (T.D.). The difference in the measured distance for the shrunken specimen and the original 10 cm side is multiplied by ten to obtain the percent of shrinkage for the specimen in each direction. The shrinkage of four specimens is averaged for the M.D. shrinkage value of the given film sample, and the shrinkage for the four specimens is averaged for the TD shrinkage value. The term “total free shrink” refers to the sum of the stretch in the M.D. and T.D. directions.

Heated Bath Shrink Force: The shrink force of a film is that force or stress required to prevent shrinkage of the film and was determined from film samples taken from each film. Four film samples were cut 1″ (2.54 cm) wide by 7″ (17.8 cm) long in the machine direction and 1″ (2.54 cm) wide by 7″ (17.8 cm) long in the traverse direction. The average thickness of the film samples was determined and recorded. Each film sample was then secured between the two clamps spaced 10 cm apart. One clamp is in a fixed position and the other is connected to a strain gauge transducer. The secured film sample and clamps were then immersed in a silicone oil bath maintained at a constant, elevated temperature for a period of five seconds. During this time, the force in grams at the elevated temperature was recorded. At the end of this time, the film sample was removed from the bath and allowed to cool to room temperature whereupon the force in grams at room temperature was also recorded. The shrink force for the film sample was then determined from the following equation wherein the results is obtained in grams per mil of film thickness (g/mil):
Shrink Force (g/mil)=F/T
wherein F is the force in grams and T is the average thickness of the film samples in mils.

Dynamic Mechanical Analyzer (DMA) Shrink Force Test: The shrink force of a film is that force or stress required to prevent shrinkage of the film at elevated temperatures and was determined from film samples taken from each film. In this test a specific isostrain is applied to a film sample and then the temperature is changed by increasing at a constant rate of 5° C. per minute until a furnace temperature of 120° C. is reached. This test measures the amount of force required to maintain that specific isostrain on the sample. The test is conducted using a Dynamic Mechanical Analyzer (DMA) Model Q-800 apparatus which is commercially available from TA Instruments of Newcastle, Del., USA. The DMA apparatus is equipped with a Film Tension Clamp Accessory (Part 984016.901 Film/Fiber Tension Clamp Kit). The DMA instrument was set up in accordance with its instruction manual and under the following conditions in isostrain mode: preload force of 0.03 Newtons and initial strain of 0.01%. Further general information regarding dynamic mechanical properties and such properties in tension is described in ASTM D4065-01 and ASTM D5026-01 both of which are incorporated by reference in their entireties. For the DMA shrink force test, film samples were cut in both the machine direction and the traverse direction using a template measuring 6.45 mm wide and 35 mm long. Each film sample was then secured between the two opposing clamps of the Film Tension Clamp Accessory which is set with the two clamps apart at the calibrated spacing of 18.0 mm. The top clamp is in a fixed position and the opposing bottom clamp is connected to a strain gauge transducer i.e. a force measuring device. The secured film sample and clamps were then enclosed in the furnace of the DMA apparatus and the temperature inside the furnace was raised at a constant rate of 5° C. per minute until a maximum temperature of 120° C. was reached. During this time the force in Newtons required to maintain the calibrated spacing was recorded and is reported for the temperature indicated.

Other useful tests are provided by the following references, which are incorporated herein in their entirety: U.S. patent application Ser. No. 09/652,591, entitled “IRRADIATED BIAXIALLY ORIENTED FILM,” by Scott Idlas; and U.S. Pat. Nos. 6,777,046 and 5,759,648.

Provided herein are non-limiting examples of the compositions, films and packages disclosed herein. In all the following examples, unless otherwise indicated, the film compositions are produced generally utilizing the apparatus and method described in U.S. Pat. No. 3,456,044 (Pahlke), which describes a coextrusion type of double bubble method, and in further accordance with the detailed description above. All percentages are by weight unless indicated otherwise.

Multilayer layer tubular films are made by a biaxial stretching orientation process. However, films of five or more layers are also contemplated. The inventive multilayer films may include additional layers or polymers to add or modify various properties of the desired film such as heat sealability, interlayer adhesion, food surface adhesion, shrinkability, shrink force, wrinkle resistance, puncture resistance, printability, toughness, gas or water barrier properties, abrasion resistance and optical properties such as gloss, haze, freedom from lines, streaks or gels. These layers may be formed by any suitable method including coextrusion, extrusion coating and lamination.

In all the following examples, unless otherwise indicated, the film compositions were produced generally utilizing the apparatus and method described in U.S. Pat. No. 3,456,044 (Pahlke), incorporated herein by reference in its entirety, which describes a coextrusion type of double bubble method and in further accordance with the detailed description above. In the following examples, all layers were extruded (coextruded in the multilayer examples) as a primary tube which was cooled upon exiting the die e.g. by spraying with tap water. This primary tube was then reheated by radiant heaters(although means such as conduction or convection heating may be used) with further heating to the draw (orientation) temperature for biaxial orientation accomplished by an air cushion which was itself heated by transverse flow through a heated porous tube concentrically positioned around the moving primary tube. Cooling was accomplished by means of a concentric air ring. Draw point temperature, bubble heating and cooling rates and orientation ratios were generally adjusted to maximize bubble stability and throughput for the desired amount of stretching or orientation. All percentages are by weight unless indicated otherwise.

### Example 1

### Preparation of a Multilayer Heat-Shrinkable Tube Member

A puncture-resistant bag can be produced that includes a heat-shrinkable tube member comprising a coextruded three-layer biaxially oriented shrink film. The exterior layer is opposable to the interior layer on either side of the barrier layer. The three layers include the following compositions:
(exterior) VLDPE:EVA:Plastomer/PVDC/VLDPE:EVA (interior)

TABLE 1
components of the three-layer tube member

| Layer | Composition | Details | Wt % of layer | Wt % of 3-layer film |
|---|---|---|---|---|
| 1 | VLDPE | Dow XU 61509.32 | 25.00 | 22.8 |
| (exterior) | | VLDPE resin | | |
| | EVA | Exxon LD 701.ID EVA resin | 27.00 | |
| | | (10.5% VA, 0.2 MI) | | |
| | Plastomer | EXACT SLP 9523 plastomer | 45.00 | |
| | | resin (0.895 g/cc; 1.0 MI) | | |
| | Process Aid | Ampacet 501582-A | 3.00 | |
| 2 | PVDC | PVDC blend (85% VDC-MA: | 100.00 | 15.8 |
| (core) | | 15% VDC-VC blend) | | |
| 3 | VLDPE | Dow XU 61509.32 | 71.50 | 61.4 |
| (interior) | | VLDPE resin | | |
| | EVA | Exxon LD 701.ID EVA resin | 23.50 | |
| | | (10.5% VA, 0.2 MI) | | |
| | Stabilizer | Ampacet 501234 VLDPE | 2.00 | |
| | | Stabilizer | | |
| | Process Aid | Ampacet 501582-A | 3.00 | |

To produce the tube member, one extruder is used for each layer. Each extruder is connected to an annular coextrusion die from which heat plastified resins are coextruded forming a primary tube. The resin mixture for each layer is fed from a hopper into an attached single screw extruder where the mixture is heat plastified and extruded through a three-layer coextrusion die into the primary tube.

Further details regarding processing temperatures for these materials during the coextrusion can be found in US2004/0043167A1 Gianni et al., published Mar. 4, 2004, which is incorporated herein by reference in its entirety.

The nominal total thickness of the three-layer film is 2.50 mils. The free shrink is measured at 90° C. by the procedure above (derived from ASTM D2732) for three layer film was about 35 (MD)×45 (TD) for a total free shrink of about 80%.

### Example 2

### Preparation of a First Laminate Film

A first laminate film can be prepared for attachment to the three layer heat-shrinkable tube member of Example 1, to form a curl-resistant bone-in food product storage bag. Specifically, the first laminate film is selected with a total free shrink at 90° C. that is at least 10 total free shrink percentage points greater than the total free shrink of the three layer tube member of Example 1.

A two layer heat-shrinkable laminate film is formed with the following configuration:
(interior) VLDPE:Plastomer:Ionomer/VLDPE:Plastomer:Ionomer (exterior)

TABLE 2
components of a first laminate film

| Layer | Composition | Details | Wt % of layer | Wt % of 2-layer film |
|---|---|---|---|---|
| 1 | VLDPE | Dow XU 61509.32 | 43.5 | 43.5 |
| (interior) | | VLDPE resin | | |
| | Plastomer | Exxon EXACT SLP 9523 | 45.00 | |
| | | plastomer resin | | |
| | | (0.895 g/cc; 1.0 MI) | | |
| | Ionomer | DuPont 1705-1 SURLYN ® | 8.00 | |
| | | Resin | | |
| | Antiblock | Ampacet 10853 Additive | 1.50 | |
| | Additive | | | |
| | Process Aid | Ampacet 501237 | 2.00 | |
| 2 | VLDPE | Dow XU 61509.32 | 45.00 | 56.5 |
| (exterior) | | VLDPE resin | | |
| | Plastomer | Exxon EXACT SLP 9523 | 45.00 | |
| | | plastomer resin | | |
| | | (0.895 g/cc; 1.0 MI) | | |
| | Ionomer | DuPont 1705-1 SURLYN ® | 8.00 | |
| | | Resin | | |
| | Process Aid | Ampacet 501237 | 2.00 | |

The two-layer laminate film is coextruded from a three layer die at a first(interior)/second(exterior) layer basis weight ratio of about 15.00:9.65:32.00 (total basis weight of 56.65). Layer 1 is coextruded from the first and second layer portions of the three layer die with a basis weight ratio of about 15.00:9.65 that together form the first(interior) layer.

The nominal thickness of the first laminate film is 4.0 mils.

The free shrink of the first laminate film was measured at 90° C. by the procedure above (derived from ASTM D2732) for first laminate film was about 52 (MD)×57 (TD) for a total free shrink of about 109%. The free shrink measured at 90° C. of the first laminate film is 29 total free shrink percentage points greater than the total free shrink at 90° C. of the three layer tube film.

### Example 3

### Preparation of a Second Laminate Film

A second laminate film can be prepared for attachment to the three layer heat-shrinkable tube member of Example 1, to form a curl-resistant bone-in food product storage bag. Specifically, the second laminate film is selected with a total free shrink at 90° C. that is at least 10 total free shrink percentage points less than the total free shrink of the first laminate film of Example 2.

A two layer heat-shrinkable laminate film is formed with the following configuration:
(interior) VLDPE:Plastomer:Ionomer/VLDPE:EVA (exterior)

TABLE 3
components of a second laminate film

| Layer | Composition | Details | Wt % of layer | Wt % of 2-layer film |
|---|---|---|---|---|
| 1 | VLDPE | Dow XU 61509.32 | 45.00 | 15.0 |
| (interior) | | VLDPE resin | | |
| | Plastomer | Exxon EXACT SLP 9523 | 45.00 | |
| | | plastomer resin | | |
| | | (0.895 g/cc; 1.0 MI) | | |
| | Ionomer | DuPont 1705-1 SURLYN ® | 8.00 | |
| | | Resin | | |
| | Process Aid | Ampacet 501237 | 2.00 | |
| 2 | VLDPE | Dow XU 61509.32 | 71.00 | 85.0 |
| (exterior) | | VLDPE resin | | |
| | EVA | Exxon LD 701.ID EVA resin | 25.00 | |
| | | (10.5% VA, 0.2 MI) | | |
| | Process Aid | Ampacet 501233 VLDPE | 4.00 | |
| | | Processing Aid | | |

The two-layer laminate film is coextruded from a three layer die at a first(interior)/second(exterior) layer basis weight ratio of about 4.2:5.65:18.2 (total basis weight of 28.05). The second(exterior) layer is produced from the second and third layer portions of the three layer die with a basis weight ratio of about 5.65:18.2 that together form the second(exterior) layer.

The nominal thickness of the second laminate film is 2.0 mils.

The free shrink value is measured at 90° C. by the procedure above (derived from ASTM D2732) for second laminate film was about 35 (MD)×45 (TD) for a total free shrink of about 80%. The free shrink measured at 90° C. of the second laminate film is 29 total free shrink percentage points less than the total free shrink at 90° C. of the first laminate film and the same as the total free shrink measured at 90° C. of the 3-layer film.

### Example 4

### Assembly of a Curl Resistant Laminate Bag

The tube member is irradiated with an election beam at a dosage level of at least about 4 megarads (MR). The tubular film is unwound and both outer surfaces are corona treated. Similarly, the puncture-resistant films are unwound and a surface of each is corona treated.

To affix the exterior surface of the tube member (Example 1) to the interior surface of the first laminate film (Example 2) on one side and the interior surface of the second laminate film (Example 3) to the opposite side of the exterior surface of the tube member (Example 1), the three films are then pressed together to ensure contact of each treated surface with another treated surface, thereby bonding the three films into a continuous three-film composite structure having a monolayer film member securely attached to each side of the lay-flat tube member. Laminate bags are formed by sealing laterally across the three-film composite structure and simultaneously severing the sealed portion from the continuous three-film composite structure.

Properties of the first laminate, the second laminate and the three-layer tube member are compared in Table 1 below.

TABLE 4
Comparison of film tube, first laminate and second laminate

| | | Total | Free Shrink | |
|---|---|---|---|---|
| | | Thickness | at 90° C. | Total Free |
| Layer | Example | (mils) | (MD × TD) | Shrink at 90° C. |
| First Laminate | 2 | 4.0 | 52 × 57 | 109 |
| Film | | | | |
| 3-Layer Film | 1 | 2.5 | 35 × 45 | 80 |
| Second | 3 | 2.0 | 35 × 45 | 80 |
| Laminate Film | | | | |

The ratio of total free shrink for each layer to every other layer is provided in Table 2 below. Each numerical value ratio in the chart is the ratio of the value of the row divided by the value for the column.

TABLE 5
Comparison of total free shrink values measured at 90° C.

| Ratio of Total Free Shrink | First Laminate | 3-Layer | Second Laminate |
|---|---|---|---|
| Values | Film | Film | Film |
| First Laminate Film | 1.00 | 1.36 | 1.36 |
| 3-Layer Film | 0.73 | 1.00 | 1.00 |
| Second Laminate Film | 0.73 | 1.00 | 1.00 |

### Example 5

### Measuring Curl Properties of Bone-In Meat Products

A bone-in meat product was sealed into the laminate bag of Example 4 (Sample 1) and into a modified laminate bag (Sample 2). The second laminate bag (Sample 2) was identical to the first laminate bag of Example 4, except that the first laminate was the laminate of Example 3 instead of the laminate from Example 2. Therefore, the second laminate bag had the same first laminate and second laminate.

The nominal thickness of the first laminate film is 4.0 mils, the nominal thickness of the second laminate film is 2.0 mils and the nominal thickness of the 3-layer film is 2.5 mils.

Each bone-in food product was a substantially rectangular bone-in meat product having a width shorter than its length, slightly curved toward the bone side before packaging, and each product was packaged with the meat side substantially lying face-down on a flat surface.

The amount of curl distortion in each packaged product was measured by the distance (in inches) the corner of the sealed product moved (curled) toward the center of the bone side of the product edge, away from the flat surface, after sealing in the laminate bag. Sample 1 showed a slight curl (0.25-inch) when packaged. The second laminate bag showed about 600% more curl distortion than the first laminate bag. A curl measurement of 0.25-inch was measured for the first laminate bag (Sample 1), while the curl measurement of the second laminate bag (Sample 2) was 1.50 inches.

TABLE 6
Comparison of laminate bags

| | First Laminate | | | Second Laminate | | | |
|---|---|---|---|---|---|---|---|
| | | | Total Free | | | Total Free | |
| | | | Shrink | | | Shrink | |
| | | Laminate | Value at | | Laminate | Value at | |
| Sample | Composition | Thickness | 90° C. | Composition | Thickness | 90° C. | Curl |
| 1 | Example 2 | 4 mils | 109 | Example 3 | 2 mils | 80 | 0.25 |
| 2 | Example 3 | 4 mils | 80 | Example 3 | 2 mils | 80 | 1.50 |

### Example 6

### DMA Shrink Force Values

DMA Shrink force values at 90° C. and 100° C. in the MD and TD were measured for the components of the bone-in meat product of Example 4 (Sample 1). Separate shrink force values were measured at each temperature for: a top half and an opposite bottom half of the exterior surface of the tube member (Example 1), the first laminate film (Example 2), and the second laminate film (Example 3). The first laminate film was attached to the top half of the exterior surface of the tube member, and the second laminate film was attached to the bottom half of the exterior surface. The average approximate thickness was determined for each film sample for which a DMA shrink force value was reported. The shrink force values and average approximate thickness values are reported in Table 7 below. In Table 7, the Newton unit of force is abbreviated “N”.

TABLE 7
Comparison of Shrink Force Measurements

| | Shrink Force (N) at 90° C. | | Shrink Force (N) at 100° C. | |
|---|---|---|---|---|
| Shrink Force | MD | TD | MD | TD |
| Measurements | (thickness in mils) | (thickness in mils) | (thickness in mils) | (thickness in mils) |
| Tube Member (top | 0.98 N | 1.19 N | 1.13 N | 1.26 N |
| exterior surface) | (3.10 mils) | (2.80 mils) | (3.10 mils) | (2.80 mils) |
| Tube Member | 1.10 N | 1.11 N | 1.22 N | 1.16 N |
| (bottom exterior | (3.00 mils) | (3.05 mils) | (3.00 mils) | (3.05 mils) |
| surface) | | | | |
| First Laminate Film | 2.50 N | 3.23 N | 2.76 N | 3.41 N |
| | (6.68 mils) | (6.68 mils) | (6.68 mils) | (6.68 mils) |
| Second Laminate | 1.66 N | 2.23 N | 1.97 N | 2.30 N |
| Film | (4.45 mils) | (4.65 mils) | (4.45 mils) | (4.65 mils) |

The ratio of shrink force at 90° C. in the MD and TD of the tube member (Example 1), the First Laminate Film (Example 2), and the Second Laminate Film (Example 3) are provided in Table 8 below. Each numerical value ratio in the chart is the ratio of the value of 20 the row divided by the value for the column.

TABLE 8
Comparison of total free shrink values measured at 90° C.

| | | First | | 3-Layer | | Second | |
|---|---|---|---|---|---|---|---|
| | | Laminate Film | | Film | | Laminate Film | |
| Ratio of Shrink Force | | MD | TD | MD | TD | MD | TD |
| Measurements | | (2.493 N) | (3.234 N) | (0.977 N) | (1.189 N) | (1.663 N) | (2.230 N) |
| First Laminate | MD (2.493 N) | 1.000 | 0.771 | 2.552 | 2.097 | 1.499 | 1.118 |
| Film | TD (3.234 N) | 1.297 | 1.000 | 3.310 | 2.720 | 1.945 | 1.450 |
| 3-Layer Film | MD (0.977 N) | 0.400 | 0.302 | 1.000 | 0.822 | 0.587 | 0.438 |
| | TD (1.189 N) | 0.477 | 0.368 | 1.217 | 1.000 | 0.715 | 0.533 |
| Second | MD (1.663 N) | 0.667 | 0.514 | 1.702 | 1.399 | 1.000 | 0.746 |
| Laminate Film | TD (2.230 N) | 0.895 | 0.699 | 2.282 | 1.876 | 1.341 | 1.000 |

Films, bags and packages may also employ combinations of characteristics as described in one or more embodiments.

The above examples are illustrative only, and should not be interpreted as limiting since further modifications of the disclosed embodiments will be apparent to those skilled in the art in view of this teaching. All such modifications are deemed to be within the scope of the embodiments disclosed herein.

1. A heat-shrinkable packaging assembly comprising:
(a) a heat-shrinkable bag film having a first wall joined to an opposable second wall to form a product receiving chamber; the first wall and the second wall each having an interior surface and an exterior surface; the product receiving chamber defined between an interior surface of the first wall and an interior surface of the second wall; the bag film having a first total free shrink value at 90° C. of at least 10%; and
(b) a heat-shrinkable exterior film sheet affixed to the exterior surface of the first wall, the exterior film sheet having a second total free shrink value at 90° C. that is at least 10 total free shrink percentage points greater than the first total free shrink value.

2. The heat-shrinkable packaging assembly of claim 1, where the second total free shrink value at 90° C. is at least 20 total free shrink percentage points greater than the first total free shrink value.

3. The heat-shrinkable packaging assembly of claim 1, where the second total free shrink value at 90° C. is at least 25 total free shrink percentage points greater than the first total free shrink value.

4. The heat-shrinkable packaging assembly of claim 1, where the second total free shrink value at 90° C. is at least 30 total free shrink percentage points greater than the first total free shrink value.

5. The heat-shrinkable packaging assembly of claim 1, where the first total free shrink value at 90° C. is at least 80%.

6. The heat-shrinkable packaging assembly of claim 1, where the heat-shrinkable bag film has a first shrink force value measured at 90° C. that is less than a second shrink force value measured at 90° C. for the heat-shrinkable exterior film sheet.

7. The heat-shrinkable packaging assembly of claim 1, where the heat-shrinkable bag film is a multilayer heat-shrinkable film comprising a core oxygen barrier layer positioned between an exterior layer and an interior layer; the exterior layer forming the exterior surface of the first wall and the exterior surface of the second wall, and the interior layer forming the interior surface of the first wall and the interior surface of the second wall of the heat-shrinkable bag film.

8. The heat-shrinkable packaging assembly of claim 7, where the exterior layer comprises an ethylene-alpha-olefin copolymer.

9. The heat-shrinkable packaging assembly of claim 7, where the interior layer comprises ethylene vinyl acetate, very low-density polyethylene, or blends thereof.

10. The heat-shrinkable packaging assembly of claim 1, where the heat-shrinkable exterior film sheet covers at least 90% of the lateral distance across the exterior surface of the first wall.

11. The heat-shrinkable packaging assembly of claim 1, where the heat-shrinkable exterior film sheet is a first heat-shrinkable exterior film sheet; and
(c) further comprising a second heat-shrinkable exterior film sheet affixed to the exterior surface of the second wall, the second exterior film sheet having a third total free shrink value at 90° C. that is at least 10 total free shrink percentage points less than the second total free shrink value.

12. The heat-shrinkable packaging assembly of claim 11, where the second total free shrink value is within about 30 total free shrink percentage points of the first total free shrink value.

13. The heat-shrinkable packaging assembly of claim 1, where the second total free shrink value is at least about 25 total free shrink percentage points greater than both the first total free shrink value and the third total free shrink value.

14. The heat-shrinkable packaging assembly of claim 11, where the second heat-shrinkable exterior film sheet has a thickness of between about 2.0 and 5.0 mils.

15. The heat-shrinkable packaging assembly of claim 1, where the heat-shrinkable exterior film sheet has a thickness of between about 2.0 mils and 5.0 mils.

16. A bone-in food product storage bag comprising:
(a) a heat-shrinkable tube member having a first tube wall joined to a second tube wall to form a product receiving chamber; the first tube wall having a first tube interior surface and a first tube exterior surface; the second tube wall having a second tube interior surface and a second tube exterior surface; the product receiving chamber defined by the first tube interior surface and the second tube interior surface; the first tube exterior surface opposable to the second tube exterior surface; the heat-shrinkable tube member having a first total free shrink value at 90° C. of at least 10%; and
(b) a first laminate film affixed to the first tube exterior surface; the first laminate film having a second total free shrink value at 90° C. that is at least 10 total free shrink percentage points greater than the first total free shrink value at 90° C.

17. The bone-in food product storage bag of claim 16, where the first total free shrink value at 90° C. is at least 80%.

18. The bone-in food product storage bag of claim 16, further comprising:
(c) a second laminate film affixed to the second tube exterior surface, the second laminate film having a third total free shrink value at 90° C. that is at least 10 total free shrink percentage points less than the second total free shrink value.

19. The bone-in food product storage bag of claim 18, where the third total free shrink value is within about 30 total free shrink percentage points of the first total free shrink value.

20. The bone-in food product storage bag of claim 18, where the second total free shrink value is at least about 25 total free shrink percentage points greater than both the first total free shrink value and the third total free shrink value.

21. The bone-in food product storage bag of claim 18, where the second laminate film covers at least 90% of the lateral distance across the second tube exterior surface.

22. The bone-in food product storage bag of claim 16, where the first tube wall and the second tube wall are formed from a single multilayer film sleeve; the first tube interior surface and the second tube interior surface joined to form an interior tube member surface defining the product receiving chamber; the first tube exterior surface and the second tube exterior surface joined to form an exterior tube member surface;
the single multilayer film sleeve comprising a core oxygen barrier layer positioned between an interior layer defining the interior tube member surface and a exterior layer defining the exterior tube member surface;
where the exterior layer comprises ethylene vinyl acetate, very low-density polyethylene, or blends thereof.

23. The bone-in food product storage bag of claim 16, where the heat-shrinkable tube member has a first shrink force value measured at 90° C. that is less than a second shrink force value measured at 90° C. for the first laminate film.

24. The bone-in food product storage bag of claim 16, where the heat-shrinkable tube member comprises a body portion enclosing the product receiving chamber and having an enclosed end and an open end; and
the heat-shrinkable tube member further comprises a sealable portion extending outwardly from the open end of the body portion and having a third tube wall opposably positioned to a fourth tube wall to define a passageway continuous with the product receiving chamber; the third tube wall joined to the first tube wall and the fourth tube wall joined to the second tube wall; where the third tube wall and the fourth tube wall can be heat sealed together to form an enclosed product receiving chamber.

25. The bone-in food product storage bag of claim 16, where the first laminate film is between about 2.0 and 5.0 mils thick.

26. The bone-in food product storage bag of claim 18, where the second laminate film is between about 2.0 and 5.0 mils thick.

27. The bone-in food product storage bag of claim 18, where:
(a) the heat-shrinkable tube member has a first total free shrink value at 90° C. of at least 80%; the first tube wall and the second tube wall are formed from a single multilayer film sleeve comprising a core oxygen barrier layer positioned between an interior layer defining the first tube interior surface and the second tube interior surface, and an exterior layer defining the first tube exterior surface and the second tube exterior surface; where the exterior layer and the interior layer each comprise ethylene vinyl acetate and very low-density polyethylene; the core oxygen barrier layer comprising PVDC; and
(b) the first laminate film affixed to the first tube exterior surface and covering at least 90% of the lateral distance across the first tube exterior surface; the first laminate film having a second total free shrink value at 90° C. of at least 90% and a thickness of about 4.0 mils; the first laminate film comprising very low-density polyethylene; and
(c) a second laminate film affixed to the second tube exterior surface and covering at least 90% of the lateral distance across the second tube exterior surface, the second outer laminate film having a thickness of about 2.0 mils and having a third total free shrink value at 90° C. that is at least 10 total free shrink percentage points less than the second total free shrink value at 90° C. of the first laminate film; and the second laminate film comprises ethylene vinyl acetate and very low density polyethylene.

28. A laminate bag comprising:
a heat-shrinkable bag having an exterior surface and an interior surface, the interior surface defining a product receiving chamber, and the heat-shrinkable bag having a total free shrink value at 90° C. of between about 60% and 180%;
a heat-shrinkable laminate affixed to the exterior surface, the heat-shrinkable laminate having a total free shrink value at 90° C. of between about 90% and 180%;
where the total free shrink value at 90° C. of the heat-shrinkable laminate is at least 10 total free shrink percentage points greater than the total free shrink value at 90° C. of the heat-shrinkable bag.

29. The laminate bag of claim 28, where the total free shrink value at 90° C. of the heat-shrinkable laminate is at least 20 total free shrink percentage points greater than the total free shrink value at 90° C. of the heat-shrinkable bag.

30. The laminate bag of claim 28, where the total free shrink value at 90° C. of the heat-shrinkable laminate is at least 25 total free shrink percentage points greater than the total free shrink value at 90° C. of the heat-shrinkable bag.

31. The laminate bag of claim 28, where the exterior surface comprises a first exterior surface opposable to a second exterior surface; the heat-shrinkable laminate is a first heat-shrinkable laminate attached to the first exterior surface; and further comprising a second heat-shrinkable laminate attached to the second exterior surface; the second heat-shrinkable laminate having a total free shrink value at 90° C. of between about 60% and 180%; and where the total free shrink value at 90° C. of the first heat-shrinkable laminate is at least 30 total free shrink percentage points greater than the total free shrink value at 90° C. of the second heat-shrinkable laminate.

32. A method of forming a puncture-resistant bag comprising the steps:
(a) providing a continuous heat-shrinkable tube film having a first tube wall and an opposed second tube wall; the first tube wall and the second tube wall together defining an interior tube surface and an exterior tube surface; the heat-shrinkable tube having a first total free shrink value at 90° C. of between about 60% and 180%;
(b) affixing a first laminate film to the exterior tube surface of the first tube wall; the first laminate film having a second total free shrink value at 90° C. is at least 10 total free shrink percentage points greater than the first total free shrink value at 90° C.

33. The method of claim 32, further comprising the steps of:
(c) affixing a second laminate film to the exterior surface of the second tube wall and covering a major portion of the surface area of the exterior surface of the second wall, the second exterior film sheet having a third total free shrink value at 90° C. that is at least 10 total free shrink percentage points less than the second total free shrink value;
(d) providing a lateral seal through the first tube wall and the second tube wall, the lateral seal extending laterally across the width of the tube; and
(e) providing a cut laterally through the first tube wall and the second tube wall proximate the lateral seal, the cut extending laterally across at least the width of the first laminate film and the second laminate film.

34. The method of claim 32, further comprising the steps of:
(c) affixing a second laminate film to the exterior surface of the second tube wall and covering a major portion of the surface area of the exterior surface of the second wall, the second exterior film sheet having a third total free shrink value at 90° C. that is at least 10 total free shrink percentage points less than the second total free shrink value;
(d) providing a first lateral seal through the first tube wall and the second tube wall, the first lateral seal extending laterally across the width of the tube;
(e) providing a second lateral seal through the first tube wall and the second tube wall, the second lateral seal extending laterally across the width of the tube; the second lateral seal being substantially parallel to the first lateral seal and the second lateral seal being positioned at a first distance from the first lateral seal, the first distance measured along the longitudinal axis of the tube film; and
(f) providing a cut laterally through the first tube wall and the second tube wall substantially perpendicular to the first lateral seal, the cut extending laterally across at least first distance between the first lateral seal and the second lateral seal.
